(19) United States
(12) Patent Application Publication
(10) Pub. No.: US 2024/0406976 A1
(43) Pub. Date: Dec. 5, 2024

(54) ASYNCHRONOUS HYBRID AUTOMATIC REPEAT REQUEST (HARQ) FEEDBACK FOR SIDELINK

(71) Applicant: QUALCOMM Incorporated, San Diego, CA (US)

(72) Inventors: Gabi SARKIS, San Diego, CA (US); Qing LI, Princeton Junction, NJ (US)

(21) Appl. No.: 18/326,791

(22) Filed: May 31, 2023

(51) Int. Cl. H04W 72/25

(52) U.S. Cl. CPC H04W 72/25

(57) ABSTRACT

Methods, systems, and devices for wireless communication are described. A first user equipment (UE) may receive a sidelink message from a second UE via one or more sidelink resources. The first UE may select a sidelink shared channel resource to use for transmission of feedback information associated with the sidelink message. The selecting may be based on one or more conditions and may be between the sidelink shared channel resource and a sidelink feedback channel resource. The first UE may transmit the feedback information to the second UE via at least the sidelink shared channel resource.

### FIELD OF TECHNOLOGY

The following relates to wireless communication, including asynchronous hybrid automatic repeat request (HARQ) feedback for sidelink.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some wireless communications systems, a UE may directly communicate with one or more other UEs via a sidelink protocol. In some cases, existing techniques for communicating feedback via the sidelink protocol may be deficient.

### SUMMARY

The described techniques relate to improved methods, systems, devices, and apparatuses that support asynchronous hybrid automatic repeat request (HARQ) feedback for sidelink. For example, the described techniques provide a framework for transmitting HARQ feedback on a physical sidelink shared channel (PSSCH). In some examples, a first user equipment (UE) may receive a sidelink message from a second UE via one or more sidelink resources. The first UE may select a sidelink shared channel resource to use for transmission of feedback information associated with the sidelink message. For example, between the sidelink shared channel resource and a sidelink feedback channel resource, the first UE may select the sidelink shared channel resource based on one or more conditions. In some examples, the first UE may transmit the feedback information to the second UE via at least the selected sidelink shared channel resource.

A method for wireless communications at a first UE is described. The method may include receiving, from a second UE, a sidelink message via one or more sidelink resources, selecting a sidelink shared channel resource to use for transmission of feedback information associated with the sidelink message, where the selecting is based on one or more conditions and is between at least the sidelink shared channel resource and a sidelink feedback channel resource, and transmitting, to the second UE, the feedback information via at least the sidelink shared channel resource.

An apparatus for wireless communications at a first UE is described. The apparatus may include at least one processor, at least one memory coupled with the at least one processor, and instructions stored in the at least one memory. The instructions may be executable by the at least one processor to cause the apparatus to receive, from a second UE, a sidelink message via one or more sidelink resources, select a sidelink shared channel resource to use for transmission of feedback information associated with the sidelink message, where the selecting is based on one or more conditions and is between at least the sidelink shared channel resource and a sidelink feedback channel resource, and transmit, to the second UE, the feedback information via at least the sidelink shared channel resource.

Another apparatus for wireless communications at a first UE is described. The apparatus may include means for receiving, from a second UE, a sidelink message via one or more sidelink resources, means for selecting a sidelink shared channel resource to use for transmission of feedback information associated with the sidelink message, where the selecting is based on one or more conditions and is between at least the sidelink shared channel resource and a sidelink feedback channel resource, and means for transmitting, to the second UE, the feedback information via at least the sidelink shared channel resource.

A non-transitory computer-readable medium storing code for wireless communications at a first UE is described. The code may include instructions executable by a processor to receive, from a second UE, a sidelink message via one or more sidelink resources, select a sidelink shared channel resource to use for transmission of feedback information associated with the sidelink message, where the selecting is based on one or more conditions and is between at least the sidelink shared channel resource and a sidelink feedback channel resource, and transmit, to the second UE, the feedback information via at least the sidelink shared channel resource.

In some examples of the method, apparatuses, and non-transitory computer-readable medium described herein, transmitting the feedback information may include operations, features, means, or instructions for transmitting an SCI message including the feedback information, where the SCI message includes a MAC-CE or a second-stage SCI message.

Some examples of the method, apparatuses, and non-transitory computer-readable medium described herein may further include operations, features, means, or instructions for transmitting, to the second UE, a first-stage SCI message that indicates that the SCI message includes the feedback information, where the SCI message includes the second-stage SCI message.

In some examples of the method, apparatuses, and non-transitory computer-readable medium described herein, the first-stage SCI message includes a format indicator field associated with the second-stage SCI message, or an indicator bit field, or both, that indicates that the second-stage SCI message includes the feedback information.

Some examples of the method, apparatuses, and non-transitory computer-readable medium described herein may further include operations, features, means, or instructions for transmitting, to the second UE, a second SCI message including second feedback information that may be associated with the feedback information.

In some examples of the method, apparatuses, and non-transitory computer-readable medium described herein, the second SCI message includes the MAC-CE and the SCI message includes the second-stage SCI message.

In some examples of the method, apparatuses, and non-transitory computer-readable medium described herein, transmitting the feedback information may include operations, features, means, or instructions for multiplexing the feedback information with sidelink data on a PSSCH and transmitting the multiplexed feedback information via at least the sidelink shared channel resource on the PSSCH.

In some examples of the method, apparatuses, and non-transitory computer-readable medium described herein, the feedback information and the sidelink data being associated with a same source identifier or a same destination identifier, the feedback information or the sidelink data satisfying a priority threshold, an availability of the sidelink data, a cast type associated with the sidelink data, or a configuration for multiplexing on the PSSCH, or any combination thereof.

In some examples of the method, apparatuses, and non-transitory computer-readable medium described herein, transmitting the feedback information may include operations, features, means, or instructions for transmitting the feedback information with second feedback information that may be associated with a second sidelink message.

In some examples of the method, apparatuses, and non-transitory computer-readable medium described herein, transmitting the feedback information with the second feedback information may include operations, features, means, or instructions for transmitting at least one codebook that indicates the feedback information and the second feedback information.

In some examples of the method, apparatuses, and non-transitory computer-readable medium described herein, transmitting the at least one codebook may include operations, features, means, or instructions for transmitting, to the second UE, a unicast message including the at least one codebook.

In some examples of the method, apparatuses, and non-transitory computer-readable medium described herein, transmitting the at least one codebook may include operations, features, means, or instructions for transmitting a broadcast message or a groupcast message including the at least one codebook.

In some examples of the method, apparatuses, and non-transitory computer-readable medium described herein, the at least one codebook includes a codebook that indicates the feedback information and the second feedback information and the at least one codebook includes a first codebook that indicates the feedback information and a second codebook that indicates the second feedback information.

In some examples of the method, apparatuses, and non-transitory computer-readable medium described herein, selecting the sidelink shared channel resource may include operations, features, means, or instructions for selecting the sidelink shared channel resource based on a priority associated with the feedback information.

In some examples of the method, apparatuses, and non-transitory computer-readable medium described herein, selecting the sidelink shared channel resource may include operations, features, means, or instructions for selecting the sidelink shared channel resource during a resource selection window that may be based on a feedback timer.

In some examples of the method, apparatuses, and non-transitory computer-readable medium described herein, a duration of the feedback timer may be based on a priority associated with the feedback information, a configured value, a preconfigured value, or a level of congestion associated with sidelink data traffic, or any combination thereof.

In some examples of the method, apparatuses, and non-transitory computer-readable medium described herein, the sidelink shared channel resource comprises a shared radio frequency (RF) spectrum band resource and selecting the sidelink shared channel resource may include operations, features, means, or instructions for selecting the sidelink shared channel resource based on performing a channel sensing procedure on a set of candidate resources including the sidelink shared channel resource.

Some examples of the method, apparatuses, and non-transitory computer-readable medium described herein may further include operations, features, means, or instructions for receiving an indication of a type of channel sensing procedure, where the channel sensing procedure includes the indicated type of channel sensing procedure.

In some examples of the method, apparatuses, and non-transitory computer-readable medium described herein, the sidelink message includes the indication of the type of channel sensing procedure.

In some examples of the method, apparatuses, and non-transitory computer-readable medium described herein, a cast type associated with the sidelink message, a capability of the second UE, a priority associated with the feedback information, a level of congestion associated with sidelink data traffic, a type of feedback associated with the feedback information, a timing associated with the sidelink shared channel resource, or a timing associated with the sidelink feedback channel resource, a configured value, a preconfigured value, or any combination thereof.

In some examples of the method, apparatuses, and non-transitory computer-readable medium described herein, the feedback information includes HARQ feedback.

A method for wireless communications at a first UE is described. The method may include transmitting, to a second UE, a sidelink message via one or more sidelink resources and receiving, from the second UE, feedback information associated with the sidelink message, where the feedback information is received via at least a sidelink shared channel resource based on a selection of the sidelink shared channel resource from among a set of multiple candidate resources for transmission of the feedback information based on one or more conditions, and where the set of multiple candidate resources includes at least the sidelink shared channel resource and a sidelink feedback channel resource.

An apparatus for wireless communications at a first UE is described. The apparatus may include at least one processor, at least one memory coupled with the at least one processor, and instructions stored in the at least one memory. The instructions may be executable by the at least one processor to cause the apparatus to transmit, to a second UE, a sidelink message via one or more sidelink resources and receive, from the second UE, feedback information associated with the sidelink message, where the feedback information is received via at least a sidelink shared channel resource based on a selection of the sidelink shared channel resource from among a set of multiple candidate resources for transmission of the feedback information based on one or more conditions, and where the set of multiple candidate resources includes at least the sidelink shared channel resource and a sidelink feedback channel resource.

Another apparatus for wireless communications at a first UE is described. The apparatus may include means for transmitting, to a second UE, a sidelink message via one or more sidelink resources and means for receiving, from the second UE, feedback information associated with the sidelink message, where the feedback information is received via at least a sidelink shared channel resource based on a selection of the sidelink shared channel resource from among a set of multiple candidate resources for transmission of the feedback information based on one or more conditions, and where the set of multiple candidate resources includes at least the sidelink shared channel resource and a sidelink feedback channel resource.

A non-transitory computer-readable medium storing code for wireless communications at a first UE is described. The code may include instructions executable by a processor to transmit, to a second UE, a sidelink message via one or more sidelink resources and receive, from the second UE, feedback information associated with the sidelink message, where the feedback information is received via at least a sidelink shared channel resource based on a selection of the sidelink shared channel resource from among a set of multiple candidate resources for transmission of the feedback information based on one or more conditions, and where the set of multiple candidate resources includes at least the sidelink shared channel resource and a sidelink feedback channel resource.

In some examples of the method, apparatuses, and non-transitory computer-readable medium described herein, receiving the feedback information may include operations, features, means, or instructions for receiving an SCI message including the feedback information, where the SCI message includes a MAC-CE or a second-stage SCI message.

Some examples of the method, apparatuses, and non-transitory computer-readable medium described herein may further include operations, features, means, or instructions for receiving, from the second UE, a first-stage SCI message that indicates that the SCI message includes the feedback information, where the SCI message includes a second-stage SCI message.

In some examples of the method, apparatuses, and non-transitory computer-readable medium described herein, the first-stage SCI message includes a format indicator field associated with the second-stage SCI message, or an indicator bit field, or both, that indicates that the second-stage SCI message includes the feedback information.

Some examples of the method, apparatuses, and non-transitory computer-readable medium described herein may further include operations, features, means, or instructions for receiving, from the second UE, a second SCI message including second feedback information that may be associated with the feedback information.

In some examples of the method, apparatuses, and non-transitory computer-readable medium described herein, the second SCI message includes a MAC-CE and the SCI message includes a second-stage SCI message.

In some examples of the method, apparatuses, and non-transitory computer-readable medium described herein, receiving the feedback information may include operations, features, means, or instructions for receiving the feedback information via at least the sidelink shared channel resource on a PSSCH, where the feedback information may be multiplexed with sidelink data on the PSSCH.

In some examples of the method, apparatuses, and non-transitory computer-readable medium described herein, receiving the feedback information may include operations, features, means, or instructions for receiving the feedback information with second feedback information that may be associated with a second sidelink message.

In some examples of the method, apparatuses, and non-transitory computer-readable medium described herein, receiving the feedback information with the second feedback information may include operations, features, means, or instructions for receiving at least one codebook that indicates the feedback information and the second feedback information.

In some examples of the method, apparatuses, and non-transitory computer-readable medium described herein, the at least one codebook includes a codebook that indicates the feedback information and the second feedback information and the at least one codebook includes a first codebook that indicates the feedback information and a second codebook that indicates the second feedback information.

In some examples of the method, apparatuses, and non-transitory computer-readable medium described herein, the selection of the sidelink shared channel resource may be based on a priority associated with the feedback information.

In some examples of the method, apparatuses, and non-transitory computer-readable medium described herein, the selection of the sidelink shared channel resource may be during a resource selection window that may be based on a feedback timer.

Some examples of the method, apparatuses, and non-transitory computer-readable medium described herein may further include operations, features, means, or instructions for transmitting, to the second UE, a second sidelink message via a second one or more sidelink resources, identifying an expiration of the feedback timer, and transmitting second feedback information associated with the second sidelink message based on the feedback timer being expired, where the second feedback information indicates a negative acknowledgment (NACK) based on the first UE failing to receive feedback responsive to the second sidelink message during a duration of the feedback timer.

In some examples of the method, apparatuses, and non-transitory computer-readable medium described herein, a duration of the feedback timer may be based on a priority associated with the feedback information, a configured value, a preconfigured value, or a level of congestion associated with sidelink data traffic, or any combination thereof.

In some examples of the method, apparatuses, and non-transitory computer-readable medium described herein, the selection of the sidelink shared channel resource may be based on a channel sensing procedure performed on a set of candidate resources including the sidelink shared channel resource.

Some examples of the method, apparatuses, and non-transitory computer-readable medium described herein may further include operations, features, means, or instructions for transmitting, to the second UE, an indication of a type of channel sensing procedure, where the channel sensing procedure includes the indicated type of channel sensing procedure.

In some examples of the method, apparatuses, and non-transitory computer-readable medium described herein, the sidelink message includes the indication of the type of channel sensing procedure.

In some examples of the method, apparatuses, and non-transitory computer-readable medium described herein, a cast type associated with the sidelink message, a capability of the second UE, a priority associated with the feedback information, a level of congestion associated with sidelink data traffic, a type of feedback associated with the feedback information, a timing associated with the sidelink shared channel resource, or a timing associated with the sidelink feedback channel resource, or any combination thereof.

In some examples of the method, apparatuses, and non-transitory computer-readable medium described herein, the feedback information includes HARQ feedback.

### BRIEF DESCRIPTION OF THE DRAWINGS

FIGS. 1 and 2 each show an example of a wireless communications system that supports asynchronous hybrid automatic repeat request (HARQ) feedback for sidelink in accordance with one or more aspects of the present disclosure.

FIGS. 3 and 4 each show an example of a process flow that supports asynchronous HARQ feedback for sidelink in accordance with one or more aspects of the present disclosure.

FIGS. 5 and 6 show block diagrams of devices that support asynchronous HARQ feedback for sidelink in accordance with one or more aspects of the present disclosure.

FIG. 7 shows a block diagram of a communications manager that supports asynchronous HARQ feedback for sidelink in accordance with one or more aspects of the present disclosure.

FIG. 8 shows a diagram of a system including a device that supports asynchronous HARQ feedback for sidelink in accordance with one or more aspects of the present disclosure.

FIGS. 9 and 10 show flowcharts illustrating methods that support asynchronous HARQ feedback for sidelink in accordance with one or more aspects of the present disclosure.

### DETAILED DESCRIPTION

In some wireless communications systems, a communication device (e.g., a user equipment (UE)) may communicate with one or more other UEs via a sidelink protocol. In some examples, the wireless communications system may enable one or more techniques for communicating feedback via the sidelink protocol (e.g., via sidelink). For example, a first UE may receive a sidelink message from a second UE via a physical sidelink shared channel (PSSCH). The first UE may transmit feedback information responsive to the sidelink message via a physical sidelink feedback channel (PSFCH). In some examples, the first UE may identify one or more resources of the PSFCH (e.g., a PSFCH resource) to use for transmission of the feedback information based on one or more resources of the PSSCH (e.g., a PSSCH resource) used to transmit the sidelink message. For example, the first UE may be configured with a mapping between PSFCH resources and PSSCH resources. In such an example, the first UE may use the configured mapping to map a PSSCH resource used to transmit the sidelink message to a PSFCH resource available for transmission of the feedback information.

In some examples, the wireless communications system may enable sidelink communications via an unlicensed radio frequency (RF) spectrum, which may also be referred to as a shared RF spectrum. In some examples, transmissions via the shared RF spectrum may be based on a channel access procedure, which may also be referred to as a clear channel assessment (CCA) procedure. For example, prior to transmitting the feedback information via the shared RF spectrum, the first UE may perform a channel access procedure to gain access to one or more PSFCH resources (e.g., to be used for transmitting the feedback information). In some examples, the channel access procedure may be successful. In such examples, the first UE may use the one or more PSFCH resources to transmit the feedback information. In some other examples, the channel access procedure may fail. In such examples, the first UE may refrain from transmitting (e.g., may drop) the feedback information or the first UE may perform another LBT procedure for access to other (e.g., subsequent) PSFCH resources. In some examples, however, PSFCH resources may occur periodically and waiting for another opportunity to transmit the feedback information (e.g., waiting for the other PSFCH resources) may lead to increased latency at the first UE.

Various aspects of the present disclosure relate to techniques for asynchronous hybrid automatic repeat request (HARQ) feedback for sidelink and, more specifically, to a framework for transmitting HARQ feedback on the PSSCH. For example, the first UE may receive a sidelink message from the second UE via a first PSSCH resource of the shared RF spectrum. The first UE may select a second PSSCH resource of the shared RF spectrum to use for transmission of the feedback information associated with the sidelink message. For example, the first UE may select the second PSSCH resource between the second PSSCH resource and a PSFCH resource (e.g., a PSFCH resource mapped to the first PSSCH resource). In some examples, the first UE may select the second PSSCH resource based on one or more conditions. For example, the first UE may select the second PSSCH resource (e.g., from among the second PSSCH resource and the PSFCH resource) based on a cast type of the sidelink message (e.g., whether the sidelink message is transmitted via a unicast transmission, a groupcast transmission, or a broadcast transmission), one or more capabilities of the second UE (or the first UE), a priority associated with the feedback information, traffic congestion associated with the wireless communications system, a type of feedback included in the feedback information, or whether the PSFCH resource occurs prior to the second PSSCH resource, a configured value (e.g., a value indicated to the first UE such as via a resource pool configuration), a preconfigured value (e.g., a value preconfigured or predefined at the first UE), or any combination thereof. In some examples, the first UE may transmit the feedback information to the second UE via at least the second PSSCH resource.

So, for example, sidelink HARQ feedback may be transmitted via PSSCH when one or more certain conditions are satisfied. This may in some cases include the selection by a UE between one or more PSSCH resources and one or more PSFCH resources (e.g., a selection of whether to use a PSSCH resource or a PSFCH resource to transmit a given HARQ feedback message), including in cases where PSFCH resources may be configured (e.g., periodically) within one or more slots to support sidelink HARQ feedback.

Aspects of the subject matter described herein may be implemented to realize one or more of the following potential advantages. For example, the techniques employed by the described communication devices may provide benefits and enhancements to the operation of the communication devices, including improved sidelink feedback operations at a UE. The operations performed by the described communication devices to improve sidelink feedback operations at the UE may include selection of a PSSCH resource based on one or more condition. In some examples, operations performed by the described communication devices may also support increased reliability of sidelink communications within a wireless communications system, among other benefits. Aspects of the disclosure are initially described in the context of wireless communications systems and process flows. Aspects of the disclosure are further illustrated by and described with reference to apparatus diagrams, system diagrams, and flowcharts that relate to asynchronous HARQ feedback for sidelink.

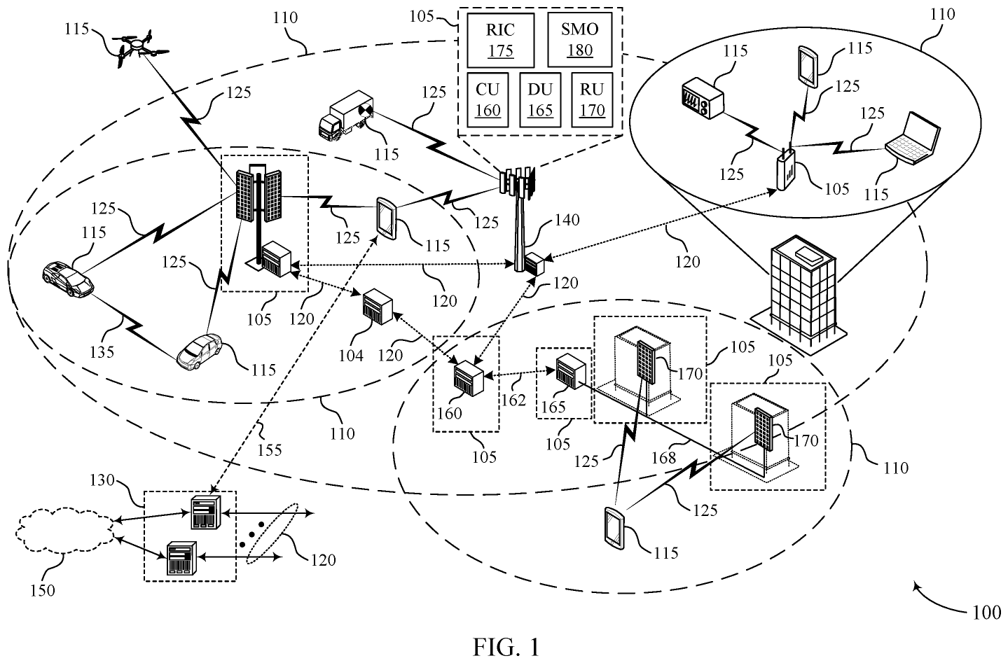

FIG. 1 shows an example of a wireless communications system 100 that supports asynchronous HARQ feedback for sidelink in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support asynchronous HARQ feedback for sidelink as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications systems 200 may enable one or more techniques for communicating feedback via the sidelink protocol (e.g., via a communication link 135). For example, a first UE 115 may receive a sidelink message from a second UE 115 via a first PSSCH resource of the shared RF spectrum. The first PSSCH resource may map to a PSFCH resource of the shared RF spectrum, which the first UE 115 may use to transmit feedback information associated with (e.g., responsive to) the sidelink message. In some examples, however, a duration between the first PSSCH resource and the PSFCH resource may be relatively long. A second PSSCH resource of the RF spectrum may be available for transmission of the feedback information. In some examples, the second PSSCH resource may occur prior to the PSFCH resource. In such examples, the first UE 115 may determine to use (e.g., may select) the second PSSCH resource for transmission of the feedback information. For example, the first UE 115 may select the second PSSCH resource between the second PSSCH resource and the PSFCH resource. The first UE 115 may transmit the feedback information to the second UE 115 via at least the second PSSCH resource. In some examples, transmitting the feedback information via the second PSSCH resource may lead to reduced latency at the first UE 115, among other possible benefits.

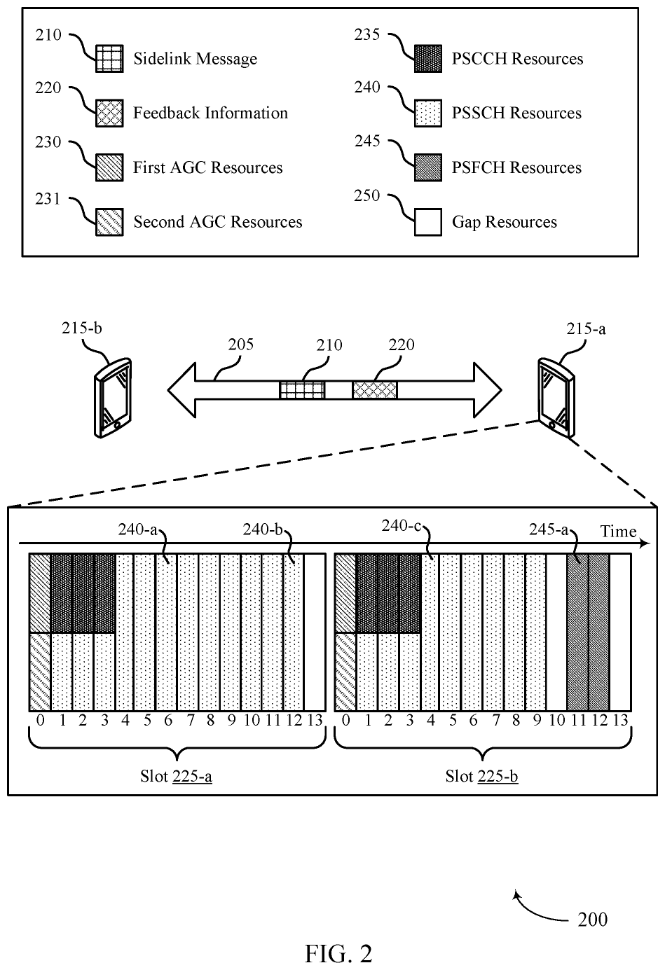

FIG. 2 shows an example of a wireless communications system 200 that supports asynchronous HARQ feedback for sidelink in accordance with one or more aspects of the present disclosure. In some examples, the wireless communications system 200 may implement or be implemented at one or more aspects of the wireless communications system 100. For example, the wireless communications system 200 may include a UE 215-a and a UE 215-b, which may be examples of a UE 115 illustrated by and described with reference to FIG. 1. In the example of FIG. 2, the UE 215-a and the UE 215-b may communicate via a communication link 205, which may be an example of a D2D communication link 135 illustrated by and described with reference to FIG. 1. For example, the communication link 205 may be an example of a sidelink (e.g., a PC5 interface).

The wireless communications system 200 may enable one or more techniques for communicating feedback via an RF access link (e.g., a Uu interface). For example, the wireless communications system 200 may support one or more HARQ feedback techniques for downlink communications, or uplink communications, or both. In some examples, the wireless communications system 200 may support transmission of HARQ feedback responsive to downlink communications (e.g., downlink HARQ feedback) via uplink control channel resources. For example, a network entity (e.g., a gNB) may provide one or more uplink resource for transmission of HARQ feedback. In some examples, the network entity may include an indication of an uplink resource (e.g., to use for transmission of HARQ feedback) in a control message providing a grant for one or more downlink resources. For example, the network entity may include the indication as part of downlink control information (DCI) including a grant for downlink resources, such as a dynamic grant or a grant that activates semi-persistent scheduling (SPS) of downlink resources. That is, in some examples, the network entity may transmit DCI to a UE (e.g., the UE 215-a, the UE 215-b) via one or more physical downlink control channel (PDCCH) resources. The DCI may include a grant for physical downlink shared channel (PDSCH) resources (e.g., may include a PDSCH grant), which the UE may use to receive downlink signaling (e.g., downlink data) from the network entity. Additionally, the DCI may indicate one or more physical uplink control channel (PUCCH) resources, which the UE may use to transmit HARQ feedback responsive to the downlink signaling (e.g., transmitted via the PDSCH resources). That is, the HARQ feedback may be transmitted on the indicated PUCCH resources.

Additionally, or alternatively, the wireless communications system 200 may support transmission of HARQ feedback responsive to downlink communications (e.g., downlink HARQ feedback) via uplink shared channel resources. For example, the UE may transmit HARQ feedback on one or more physical uplink shared channel (PUSCH) resources. In some examples, the HARQ feedback may be included in uplink control information (UCI). That is, UCI including HARQ feedback may be multiplexed on the PUSCH. For example, under some conditions, such as conditions in which PUSCH resources overlap with indicated PUCCH resources, the UE (e.g., the UE 215-a, the UE 215-b) may refrain from transmitting UCI on the PUCCH and may multiplex the UCI (e.g., including HARQ feedback) on the PUSCH.

In some examples, the UE may transmit the HARQ feedback via the PUSCH in accordance with one or more modes. For example, the UE may transmit the HARQ feedback in accordance with a mode of providing feedback in which HARQ feedback may be transmitted without periodic feedback resources determined via a mapping (e.g., via an implicit mapping). In some examples, such a mode for providing feedback may be referred to as asynchronous HARQ feedback. In other words, asynchronous HARQ may refer to a mode for providing feedback in which a grant (e.g., each grant or SPS activation) may indicate one or more PUCCH resources for transmission of HARQ feedback.

In some examples, the wireless communications system 200 may enable one or more techniques for communicating feedback via a sidelink (e.g., the communication link 205). For example, the wireless communications system 200 may support transmission of feedback responsive to sidelink communications (e.g., sidelink HARQ feedback) via sidelink feedback channel resources (e.g., on a sidelink feedback channel). That is, feedback for sidelink may be transmitted on a PSFCH.

As illustrated in the example of FIG. 2, sidelink feedback channel resources (e.g., PSFCH resources 245) may occur periodically. That is, the UEs 215 may be configured with one or more of the PSFCH resources 245 that occur (e.g., appear) periodically. In some examples, the PSFCH resources 245 may occur in accordance with a periodicity (e.g., a periodicity of 1 slot, 2 slots, 4 slots, or some other suitable quantity of slots). For example, the UE 215-a and the UE 215-b may transmit (or receive) sidelink communications in accordance with a slot format. For example, a slot format available for sidelink communications may include 14 symbols (e.g., symbols 0 through 13). The slot format may include symbols allocated for automatic gain control (AGC), physical sidelink control channel (PSCCH) transmissions, PSSCH transmissions, PSFCH transmissions, or any combination thereof. As illustrated in the example of FIG. 2, a slot format available for sidelink communications during a slot 225-a may include AGC resources (e.g., first AGC resources 230, second AGC resources 231), sidelink control channel resources (e.g., PSCCH resources 235), sidelink shared channel resources (e.g., PSSCH resources 240), and gap resources 250. Additionally, a slot format available for sidelink communications during a slot 225-b may include first AGC resources 230, second AGC resources 231, PSCCH resources 235, PSSCH resources 240, gap resources 250, and PSFCH resources 245. That is, the PSFCH resources 245 may not occur during the slot 225-a and may occur during the slot 225-b. In other words, the PSFCH resources 245 may occur in accordance with a periodicity such that some slots (e.g., the slot 225-a) may lack one or more of the PSFCH resources 245 while other slots (e.g., the slot 225-b) may include one or more of the PSFCH resources 245. In some examples, the first AGC resources 230 and the second AGC resources 231 may be included in an AGC symbol that may be a copy of the following symbol. For example, in the slots 225, the first AGC resources 230 in symbol 0 may include (e.g., carry) a copy of the PSCCH resources 235 in symbol 1. Additionally, or alternatively, in the slots 225, the second AGC resources 231 in symbol 0 may include (e.g., carry) a copy of the PSSCH resources 240 in symbol 1. In some examples, the PSFCH resources 245 may be disabled (e.g., via a configuration). That is, in some examples, feedback transmissions via one or more of the PSFCH resources 245 may be disabled.

In some examples, the UEs 215 may be provided with (e.g., configured with, indicated) a mapping between the PSSCH resources 240, which may be used for a data transmission, and the PSFCH resources 245, which may be used for a feedback transmission (e.g., responsive to the data transmission). In other words, the UEs 215 may be configured with a mapping between a data transmission on the PSSCH and feedback resources on the PSFCH (e.g., the PSFCH resources 245). For example, the UE 215-a may receive a data transmission from the UE 215-b via one or more of the PSSCH resources 240 (e.g., in a subchannel of a slot, such as the slot 225-a or the slot 225-b). In such an example, the UE 215-a may map the PSSCH resources 240 occupied by the data transmission (or a portion of the data transmission) to one or more of the PSFCH resources 245, which the UE 215-a may use to transmit feedback to the UE 215-b (e.g., feedback responsive to the data transmission). For example, the data transmission may start in subchannel j (e.g., a frequency allocation, such as one or more resource blocks) of slot i. In such an example, the UE 215-a may map subchannel j of slot i (e.g., time and frequency resources in which the data transmission started) to the one or more of the PSFCH resources 245. As an illustrative example, the data transmission may start in a PSSCH resource 240-a (e.g., a subchannel of symbol 6 of the slot 225-a). In some examples, the PSSCH resource 240-a may map to a PSFCH resource 245-a (e.g., a subchannel of symbol 11 of the slot 225-b).

In some examples, periodically occurring feedback resources may provide one or more benefits for sidelink communications. For example, periodically occurring feedback resources (e.g., the PSFCH resources 245) may provide one or more benefits for a distributed system with groupcast transmissions. That is, the mapping between the PSSCH resources 240 and the PSFCH resources 245 may enable feedback transmissions to occur without coordination (e.g., between the UEs 215 or via a network entity). That is, the mapping may reduce (e.g., avoid) management of resources for feedback transmissions. For example, a groupcast transmission may include transmission of negative feedback from two or more UEs (e.g., a relatively large quantity of UEs) via a same resource (e.g., a same one or more of the PSFCH resources 245). Alternatively, a groupcast transmission may include transmission of positive feedback or negative feedback, or both, from a group of UEs (e.g., from each UE of a group of known UEs). As such, the groupcast transmission may include a relatively large quantity of feedback. In some examples, the mapping between the PSSCH resources 240 and the PSFCH resources 245 may reduce overhead associated with coordinating sidelink feedback resources (e.g., one or more of the PSFCH resources 245) for a groupcast transmission of a relatively large quantity of feedback. That is, the mapping (e.g., an implicit mapping between the PSSCH resources 240 and the PSFCH resources 245) may reduce signaling (e.g., may avoid explicit signaling) used for determining one or more of the PSFCH resources 245 (e.g., which of the PSFCH resources 245) to use for a groupcast transmission (e.g., that may include a relatively large quantity of feedback).

In some examples, to reduce overhead, the UEs 215 may be configured to use a relatively low quantity of the PSFCH resources 245 to provide feedback. That is, the PSSCH resources 240 (e.g., each of the PSSCH resources 240) may be mapped to a relatively small quantity of the PSFCH resources 245, such that resource utilization for sidelink feedback may be relatively low. For example, the UEs 215 may be configured to use one physical resource block (PRB) per feedback indication (e.g., per acknowledgment (ACK), per negative acknowledgment (NACK)), which may lead to reduced overhead (e.g., for a relatively large groups of UEs). In some examples, however, using a single PRB per feedback indication may constrain feedback messages to a relatively small payload size. That is, periodically occurring feedback resources, such as the PSFCH resources 245, may include a single PRB (or a relatively small quantity of PRBs), which may accommodate relatively small payloads (e.g., a feedback payload of 1 bit, 2 bits, or some other suitable quantity of bits). Additionally, use of periodically occurring feedback resources, such as the PSFCH resources 245, may lead to a relatively rigid feedback scheme that may be incompatible with other feedback schemes that may be used for sidelink. For example, forward compatibility of such a feedback scheme may be constrained.

In some examples, periodically occurring feedback resources, such as the PSFCH resources 245, may constrain opportunities for the UEs 215 to provide feedback (e.g., due to listen-before-talk (LBT) failure in unlicensed spectrum). For example, the UEs 215 may be configured to use an unlicensed (shared) RF spectrum band (e.g., shared RF spectrum) for sidelink communications, in which transmissions via the shared RF spectrum may depend on whether a channel access procedure (e.g., an LBT procedure) for one or more feedback resources is successful. That is, prior to transmitting feedback over the shared RF spectrum (e.g., via one or more of the PSFCH resources 245), the UEs 215 may perform an LBT procedure to gain access to the PSFCH. In some examples, the LBT procedure may be successful. In such examples, the UEs 215 may use one or more of the PSFCH resources 245 to transmit the feedback. In some other examples, the LBT procedure may fail. In such examples, the UEs 215 may drop the feedback (e.g., refrain from transmitting the feedback) or wait for another opportunity to perform another LBT procedure for access to other (e.g., subsequent) PSFCH resources. In the example of FIG. 2, the UE 215-a may determine to transmit feedback to the UE 215-b. The UE 215-a may perform an LBT procedure to access the PSFCH for transmission of the feedback. In some examples, the UE 215-a may perform the LBT procedure during a slot occurring prior to the slot 225-a. In such examples, the LBT procedure may fail and a next opportunity for the UE 215-a to transmit feedback via the PSFCH (e.g., a next occurrence of the PSFCH resources 245) may be during the slot 225-b, which may lead to increased latency at the UE 215-a. In other words, periodically occurring feedback resources may lead to relatively high latency, for example, depending on a configured PSFCH period (e.g., a preconfigured PSFCH period, a periodicity of the PSFCH resources 245) and a time instanced during which a data transmission may be received.

In some examples, one or more techniques for asynchronous HARQ feedback for sidelink, as described herein, may provide an efficient mechanism for transmitting asynchronous HARQ feedback using a resource pool (e.g., an organization unit for sidelink, time and frequency resources available for sidelink communications) shared between multiple devices that may support multiple (e.g., different) features. For example, such techniques may provide a framework for transmitting HARQ feedback on the PSSCH and the framework may be compatible with other frameworks that may be used for transmitting feedback on the PSFCH. As illustrated in the example of FIG. 2, the UE 215-a may receive a sidelink message 210 from the UE 215-b (e.g., via the shared RF spectrum). As an illustrative example, the UE 215-a may receive the sidelink message 210 via the PSSCH resource 240-a (e.g., during symbol 6 of the slot 225-a). In some examples, the PSSCH resource 240-a may map to a PSFCH resource 245-a, which the UE 215-a may use for transmission of feedback information responsive to the sidelink message 210 (e.g., feedback information 220). In other words, the PSFCH resource 245-a (e.g., symbol 11 of slot 225-b) may be available for transmission of the feedback information 220. Additionally, one or more of the PSSCH resources 240 may be available for transmission of the feedback information 220. For example, a PSSCH resource 240-b or a PSSCH resource 240-c, or both, may be available for transmission of the feedback information 220. In other words, a set of candidate resources for transmission of the feedback information 220 may include the PSSCH resource 240-b, the PSSCH resource 240-c, and the PSFCH resource 245-a. In some examples, the UE 215-a may select the PSSCH resource 240-b or the PSSCH resource 240-c for transmission of the feedback information 220. That is, the UE 215-a may select one or more of the PSSCH resources 240 from among the set of candidate resources. In other words, between the PSSCH resource 240-b, the PSSCH resource 240-c, and the PSFCH resources 245-a, the UE 215-a may select the PSSCH resources 240-b or the PSSCH resource 240-c for transmission of the feedback information 220.

In some examples, the UE 215-a may select the PSSCH resource 240-b or the PSSCH resource 240-c for transmission of the feedback information 220 based on one or more conditions. For example, whether the UE 215-a may use one or more of the PSFCH resources 245 (e.g., a periodic PSFCH resource, such as the PSFCH resource 245-a) or one or more of the PSSCH resources 240 (e.g., the PSSCH resource 240-b or the PSSCH resource 240-c) for feedback may be based on (e.g., subject to) one or more conditions. In some examples, the one or more conditions may include a cast type of the sidelink message 210, one or more capabilities of the UE 215-b, a priority associated with the feedback information 220, congestion (e.g., traffic congestion) associated with the wireless communications system 200, a type of feedback included in the feedback information 220, whether the available PSFCH resource (e.g., the PSFCH resource 245-a) occurs prior to the available PSSCH resources (e.g., the PSSCH resource 240-b, the PSSCH resource 240-c), a configured value (e.g., a value indicated to the UE 215-a such as via a resource pool configuration), a preconfigured value (e.g., a value preconfigured or predefined at the UE 215-a), or any combination thereof. The UE 215-a may transmit the feedback information 220 via the PSSCH resource 240-b (e.g., during symbol 12 of the slot 225-a) or via the PSSCH resource 240-c (e.g., during symbol 4 of the slot 225-b). In some examples, a container for the feedback information 220 may include sidelink control information (SCI), a MAC-control element (MAC-CE), or another type of message that may be transmitted via the PSSCH. In some examples, transmitting the feedback information 220 via the PSSCH resource 240-b or the PSSCH resource 240-c may lead to reduced latency of sidelink communications between the UEs 215, among other possible benefits.

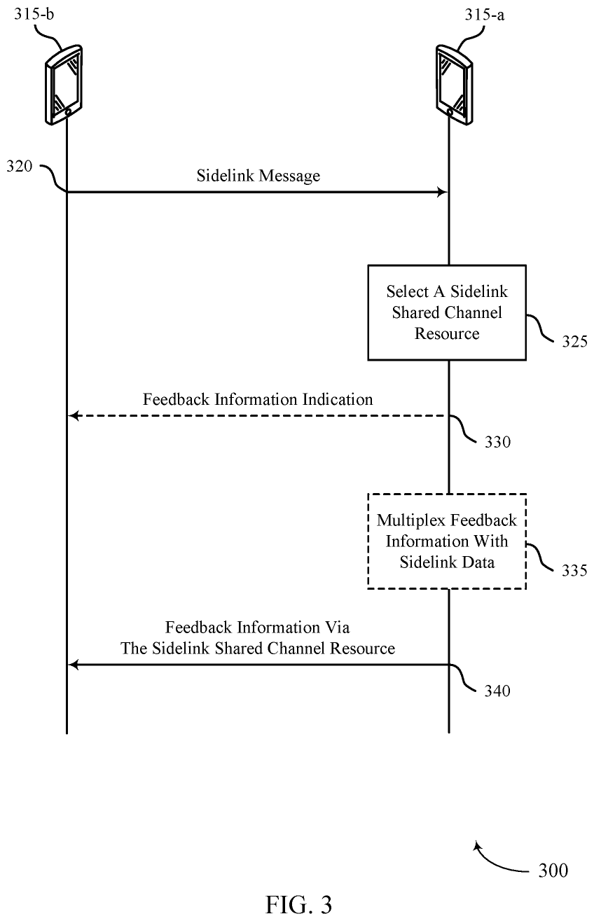

FIG. 3 shows an example of a process flow 300 that supports asynchronous HARQ feedback for sidelink in accordance with one or more aspects of the present disclosure. In some examples, the process flow 300 may implement one or more aspects of wireless communications system 100 and the wireless communications system 200. For example, the process flow 300 may include example operations associated with a UE 315-a and a UE 315-b, which may be examples of a UE illustrated by and described with reference to FIGS. 1 and 2. The operations performed by the UEs 315 may support improvements to communications between the UEs 315, among other benefits. In the following description of the process flow 300, the operations between the UEs 315 may occur in a different order than the example order shown. Additionally, or alternatively, the operations performed by the UEs 315 may be performed in different orders or at different times. Some operations may also be omitted or combined. The UEs 315 may support a framework for transmitting HARQ feedback on a PSSCH.

At 320, the UE 315-a may receive a sidelink message from the UE 315-b. The sidelink message may be an example of a sidelink message illustrated by and described with reference to FIGS. 1 and 2. For example, the UE 315-a may receive the sidelink message via one or more sidelink resources (e.g., of a shared RF spectrum band).

At 325, the UE 315-a may select a sidelink shared channel resource (e.g., a PSSCH resource of the shared RF spectrum band) to use for transmission of feedback information. That is, feedback information (e.g., sidelink HARQ feedback) may be transmitted on the PSSCH (e.g., from the UE 315-a). In some examples, the feedback information may be an example of feedback information illustrated by and described with reference to FIGS. 1 and 2. For example, the feedback information may be associated with (e.g., responsive to) the sidelink message received at 320. In some examples, the UE 315-a may select the sidelink shared channel resource based on one or more conditions and between at least the sidelink shared channel resource and a sidelink feedback channel resource (e.g., a PSFCH resource of the shared RF spectrum band). The sidelink feedback channel resource may be an example of a PSFCH resource illustrated by and described with reference to FIGS. 1 and 2. For example, the sidelink feedback channel resource may be a periodic resource (e.g., a periodic PSFCH resource).

The one or more conditions used for selection of the sidelink shared channel resource (e.g., at 325) may be examples of conditions as described with reference to FIG. 2. For example, the one or more conditions may include a cast type associated with the sidelink message (e.g., whether the sidelink message is transmitted via a unicast transmission, a groupcast transmission, or a broadcast transmission), a capability of the UE 315-b (or the UE 315-a), a priority associated with the feedback information, a level of congestion associated with sidelink data traffic, a type of feedback associated with the feedback information (e.g., a transport block (TB) level or granularity of the feedback information), a timing associated with the sidelink shared channel resource, or a timing associated with the sidelink feedback channel resource, a configured value (e.g., a value indicated to the UE 315-a such as via a resource pool configuration), a preconfigured value (e.g., a value preconfigured or predefined at the UE 315-a), or any combination thereof. In other words, whether the periodic PSFCH resource or the PSSCH resource is used for transmission of the feedback information may be based on (e.g., subject to) a cast type of the PSSCH transmission corresponding to the feedback information (e.g., a cast type of the sidelink message, a cast type of the data transmission for which the feedback information is generated), a capability of the UE 315-b (e.g., a capability of the UE that sent the data for which the feedback information is generated), a priority of the feedback information (e.g., a priority of the PSSCH transmission including the feedback information), system congestion (e.g., a level of congestion associated with sidelink data traffic), a type of feedback associated with the feedback information (e.g., whether the feedback information is generated at the TB-level or with a relatively finer granularity than a TB), a payload size of the feedback information (e.g., a quantity of bits to be transmitted, a quantity of bits indicating the feedback information), a timing of the sidelink shared channel resource relative to the sidelink feedback channel resource (e.g., whether the sidelink feedback channel resource occurs prior to the sidelink shared channel resource).

In some examples, the selection of the sidelink shared channel resource (e.g., at 325) may be based on a resource selection procedure (e.g., including channel sensing). That is, the UE 315-a may use (e.g., perform) one or more resource selection procedures to select the sidelink shared channel resource (e.g., from among one or more candidate sidelink shared channel resources). For example, to select the sidelink shared channel resource, the UE 315-a may perform a channel sensing procedure (e.g., including resource selection) on a set of candidate resources including the sidelink shared channel resource. In other words, resource selection at the UE 315-a for transmission of the feedback information (e.g., for a HARQ feedback transmission) may be in accordance with one or more resource selection procedures. In some examples, such as in accordance with a resource selection procedure, the UE 315-a may select the sidelink shared channel resource based on a priority associated with the feedback information. In such an example, the priority used for the selection may correspond to a highest priority of feedback information (e.g., all feedback information) included in the transmission. That is, a transmission including the feedback information associated with the sidelink message may be associated with multiple priorities and the UE 315-a may use the highest priority among the multiple priorities for resource selection. For example, the transmission including the feedback information may include other feedback information associated with other sidelink messages. In such an example, the transmission may be associated with multiple priorities (e.g., the feedback information and the other feedback information may be associated with different priorities) and a highest priority among the multiple priorities may be used to select the sidelink shared channel resource used for the transmission (e.g., may be used for the resource selection procedure).

In some examples, the resource selection procedure may occur during a resource selection window. That is, the UE 315-a may select the sidelink shared channel resource (e.g., at 325) during a resource selection window. In some examples, the resource selection window may be based on a feedback timer. In other words, the resource selection window may be bounded by a feedback time constraint (e.g., the feedback timer). In some examples, a duration of the feedback timer may be based on a packet delay budget (PDB). In some other examples, a duration of the feedback timer may be based on priority of the feedback information. For example, the feedback information may have a relatively high priority. In such an example, the feedback timer may have a relatively short duration, such that the UE 315-a may transmit the feedback information relatively quickly. In some other examples, the feedback information may have a relatively low priority. In such examples, the feedback timer may have a relatively long duration, such that the UE 315-a may multiplex the feedback information with other feedback information (e.g., to conserve system resources). Additionally, or alternatively, the duration may be based on system congestion (e.g., current system congestion). In some examples, the duration of the feedback timer may be configured (e.g., preconfigured) at the UE 315-a. In other words, the duration of the feedback timer may be based on a priority associated with the feedback information, a configured value (e.g., a value configured at the UE 315-a, such as via signaling), a preconfigured value (e.g., a value that may be preconfigured or predefined at the UE 315-a), or a level of congestion associated with sidelink data traffic, or any combination thereof.

In some examples, the feedback timer may be configured at the UE 315-a and the UE 315-b. For example, the UE 315-b may determine an upper bound of the feedback timer (e.g., a threshold duration during which the UE 315-b may receive feedback information) based on a priority associated with the sidelink message. In some examples, the UE 315-b may fail to receive the feedback information prior to an expiration of the feedback timer (e.g., prior to the threshold duration being satisfied). For example, the UE 315-b may identify an expiration of the feedback timer and a lack of feedback information responsive to the sidelink message. In such an example, the UE 315-b may determine that feedback responsive to the sidelink message (e.g., the feedback information) corresponds to a negative acknowledgment. In other words, if the feedback timer expires, the UE 315-b (e.g., the UE expecting feedback) may determine that feedback responsive to the sidelink message is negative feedback. In some examples, in response to the expiration of the feedback timer, the UE 315-b may transmit second feedback information associated with the second sidelink message. That is, a lower layer of a protocol stack at the UE 315-b may transmit second feedback information associated with the second sidelink message to a higher layer of a protocol stack at the UE 315-b. In some examples, such as examples in which the UE 315-b identifies an expiration of the feedback timer and a lack of feedback information responsive to the sidelink message, the UE 315-b may transmit second feedback information that indicates a negative acknowledgment. In other words, the second feedback information may indicate a NACK based on the UE 315-b failing to receive feedback responsive to the sidelink message (e.g., failing to receive the feedback information) during the duration of the feedback timer.

In some examples, the resource selection procedure (e.g., used for selecting the sidelink shared channel resource at 325) may include one or more channel sensing procedures. For example, the resource selection procedure may include full-sensing, partial-sensing, or random selection, or any combination thereof. In some examples, the UE 315-a may be configured with a type of channel sensing procedure to use for resource selection (e.g., to select the sidelink shared channel resources). That is, a configuration (e.g., a preconfiguration) may indicate whether full-sensing, partial-sensing, or random selection may be used for selecting the sidelink shared channel resource. For example, the UE 315-a may receive an indication of a type (e.g., a mode) of channel sensing procedure. In such an example, the UE 315-a may perform channel sensing in accordance with the indicated type of channel sensing procedure. That is, the channel sensing procedure may include the indicated type of channel sensing procedure. In some examples, the UE 315-a may receive the indication of the type of channel sensing procedure via the sidelink message (e.g., received at 320). That is, the sidelink message may include the indication of the type of channel sensing procedure. In some examples, the sidelink message may include a flag (e.g., a preconfiguration flag) that indicates the type of channel sensing procedure. For example, the sidelink message may include a flag (e.g., a preconfiguration flag) that indicates whether the UE 315-a may use one or more of full-sensing, partial-sensing, or random selection for selecting the sidelink shared channel resource.

At 340, the UE 315-a may transmit the feedback information to the UE 315-b via the sidelink shared channel resource. In some examples, the UE 315-a may transmit the feedback information to the UE 315-b using an SCI message. For example, the UE 315-a may transmit the feedback information using a second-stage SCI (SCI-2) message. Additionally, or alternatively, the UE 315-a may transmit the feedback information using a MAC-CE or another type of message that may be transmitted via the PSSCH (e.g., a higher layer message). In other words, a container for the feedback information may include SCI-2, MAC-CE, or one or more other type of messages transmitted on the PSSCH (e.g., a higher layer message). In some examples, the UE 315-a may transmit the feedback information using both an SCI-2 message and a MAC-CE (e.g., associated with the SCI-2 message). For example, the UE 315-a may lack data (e.g., sidelink data) to transmit to the UE 315-b on the PSSCH (e.g., via a MAC-CE associated with the SCI-2). In such an example, the UE 315-a may indicate the feedback information using (e.g., may include the feedback information in, may indicate the feedback information via) both the SCI-2 and the MAC-CE. In other words, HARQ feedback may be transmitted on both SCI-2 and MAC-CE.

In some examples, at 330, the UE 315-a may transmit a feedback information indication to the UE 315-b that indicates whether an SCI-2 message includes the feedback information. For example, the UE 315-a may use first-stage SCI (SCI-1) to indicate whether SCI-2 may carry the feedback information. That is, the UE 315-a may transmit an SCI-1 message (e.g., via the PSCCH) that indicates that an SCI-2 message (e.g., transmitted via the PSSCH) includes the feedback information. For example, the SCI-1 message may include one or more indicator bits (e.g., reserved bits) that the UE 315-a may use to indicate that the SCI-2 message includes the feedback information. Additionally, or alternatively, the SCI-1 message may include a format indicator field associated with the SCI-2 message. For example, the format indicator field may indicate a format for the SCI-2 message. In some examples, the UE 315-a may use the format indicator field to indicate that the SCI-2 message includes the feedback information. In other words, a format for the SCI-2 message indicated via the format indicator field may indicate to the UE 315-b that the SCI-2 message includes the feedback information. In other words, the SCI-1 message may include a format indicator field associated with the SCI-2 message, or an indicator bit field, or both, that indicates that the SCI-2 message includes the feedback information.

In some examples, at 335, the UE 315-a may multiplex the feedback information with other data (e.g., sidelink data) on the PSSCH. That is, the feedback information (e.g., HARQ feedback) may be multiplexed with sidelink data on the PSSCH. In such examples, the UE 315-a may transmit the multiplexed feedback information via the sidelink shared channel resource on the PSSCH (e.g., at 340). In some examples, multiplexing the feedback information with the sidelink data on the PSSCH may be based on one or more constraints. For example, multiplexing the feedback information with the sidelink data on the PSSCH may be based on a source identifier (ID) for the feedback information and the sidelink data being the same, a destination ID for the feedback information and the sidelink data being the same, one or more priorities of the feedback information and the sidelink data being the same, a priority of the feedback information or the sidelink data being below a threshold, or a priority of the feedback information of the sidelink data being above a threshold. Additionally, or alternatively, multiplexing the feedback information with sidelink data on the PSSCH sidelink data may be based on whether the UE 315-a has sidelink data to transmit. In some examples, multiplexing the feedback information with sidelink data on the PSSCH may be based on a cast type of the sidelink data. Additionally, or alternatively, multiplexing the feedback information with the sidelink data on the PSSCH may be based on a configuration (e.g., a preconfiguration) that enables (or disables) multiplexing of feedback information with sidelink data on the PSSCH. In other words, multiplexing the feedback information with sidelink data on the physical sidelink shared channel may be based on the feedback information and the sidelink data being associated with a same source identifier or a same destination identifier, the feedback information or the sidelink data satisfying a priority threshold, an availability of the sidelink data, a cast type associated with the sidelink data, or a configuration for multiplexing on the PSSCH, or any combination thereof. In some examples, the UE 315-a may lack sidelink data to transmit via the PSSCH. That is, the UE 315-a may lack sidelink data to multiplex with the feedback information on the PSSCH. In such examples, the UE 315-a may transmit the feedback information (e.g., HARQ feedback) via both a MAC-CE and an SCI-2 message. In some examples, multiplexing the feedback information on the PSSCH (e.g., with the sidelink data) may reduce latency and increase throughput for sidelink communications between the UEs 315, among other benefits.

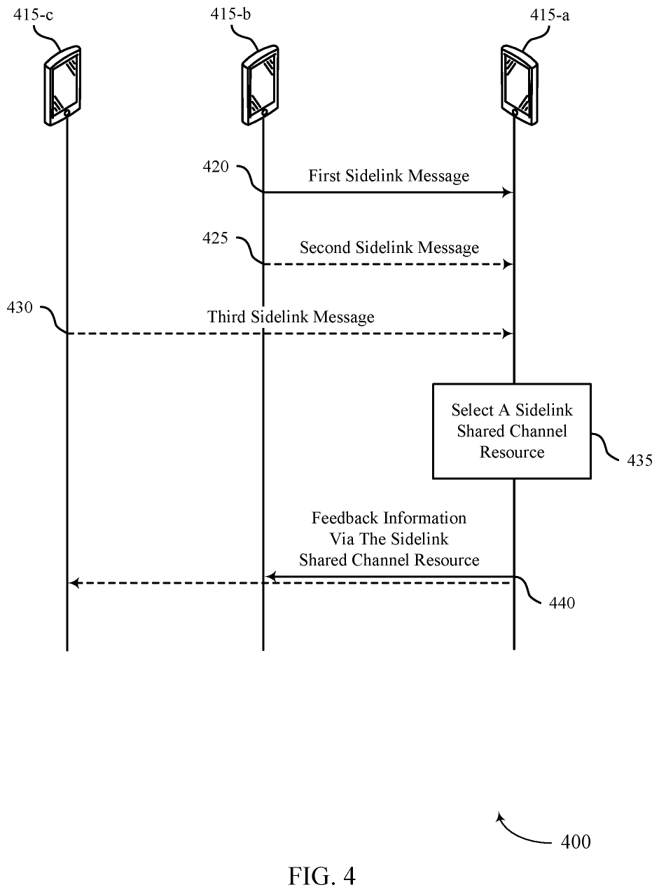

FIG. 4 shows an example of a process flow 400 that supports asynchronous HARQ feedback for sidelink in accordance with one or more aspects of the present disclosure. In some examples, the process flow 400 may implement one or more aspects of wireless communications system 100, the wireless communications system 200, and the process flow 300. For example, the process flow 400 may include example operations associated with a UE 415-a, a UE 415-b, and a UE 415-c, which may be examples of a UE illustrated by and described with reference to FIGS. 1 through 3. The operations performed by the UEs 415 may support improvements to communications between the UEs 415, among other benefits. In the following description of the process flow 400, the operations between the UEs 415 may occur in a different order than the example order shown. Additionally, or alternatively, the operations performed by the UEs 415 may be performed in different orders or at different times. Some operations may also be omitted or combined. The UEs 415 may support a framework for transmitting HARQ feedback on a PSSCH.

At 420, the UE 415-a may receive a first sidelink message from the UE 415-b. The first sidelink message may be an example of a sidelink message illustrated by and described with reference to FIGS. 1 through 3. For example, the UE 315-a may receive the first sidelink message via one or more sidelink resources (e.g., of a shared RF spectrum band).

At 435, the UE 415-a may select a sidelink shared channel resource (e.g., a PSSCH resource of the shared RF spectrum band) to use for transmission of feedback information. In some examples, the feedback information may be an example of feedback information illustrated by and described with reference to FIGS. 1 through 3. For example, the feedback information may include first feedback information that is associated with (e.g., responsive to) the first sidelink message received at 420. In some examples, the UE 415-a may select the sidelink shared channel resource based on one or more conditions and between at least the sidelink shared channel resource and a sidelink feedback channel resource (e.g., a PSFCH resource of the shared RF spectrum band). The sidelink feedback channel resource may be an example of a PSFCH resource illustrated by and described with reference to FIGS. 1 through 3. For example, the sidelink feedback channel resource may be a periodic resource (e.g., a periodic PSFCH resource). Additionally, the one or more conditions used for selection of the sidelink shared channel resource (e.g., at 435) may be examples of conditions as described with reference to FIGS. 2 and 3. For example, the one or more conditions may include a cast type associated with the first sidelink message, a capability of the UE 415-b (or the UE 415-c), a priority associated with the feedback information (e.g., a highest priority associated with the feedback information), a level of congestion associated with sidelink data traffic, a type of feedback associated with the feedback information, a timing associated with the sidelink shared channel resource, or a timing associated with the sidelink feedback channel resource, a configured value, a preconfigured value, or any combination thereof.

At 440, the UE 415-a may transmit the feedback information to the UE 415-b (or the UE 415-b and the UE 415-c) via the sidelink shared channel resource. In some examples, the UE 415-a may transmit the feedback information using an SCI-2 message. Additionally, or alternatively, the UE 415-a may transmit the feedback information using a MAC-CE. In some examples, the UE 415-a may transmit the feedback information using another type of message that may be transmitted via the PSSCH (e.g., a higher layer message). In other words, a container for the feedback information may include SCI-2, MAC-CE, or one or more other type of messages transmitted on the PSSCH (e.g., a higher layer message). In some examples, the feedback information may include the first feedback information and other feedback information associated with other sidelink messages.

For example, at 425, the UE 415-a may receive a second sidelink message from the UE 415-b. The second sidelink message may be an example of a sidelink message illustrated by and described with reference to FIGS. 1 through 3. For example, the UE 415-a may receive the second sidelink message via one or more sidelink resources (e.g., of the shared RF spectrum band).

Additionally, or alternatively, at 430, the UE 415-a may receive a third sidelink message from the UE 415-c. The third sidelink message may be an example of a sidelink message illustrated by and described with reference to FIGS. 1 through 3. For example, the UE 415-a may receive the third sidelink message via one or more sidelink resources (e.g., of the shared RF spectrum band).

In some examples, the UE 415-a may multiplex the first feedback information with second feedback information that is associated with the second sidelink message or third feedback information that is associated with the third sidelink message, or both. In other words, the UE 415-a may receive multiple transmissions (e.g., the first sidelink message and one or both of the second sidelink message and the third sidelink message) and feedback for the multiple transmissions may be multiplexed together. In such an example, the feedback information (e.g., transmitted at 440) may include the first feedback information and one or both of the second feedback information and the third feedback information.

In some examples, such as examples in which feedback for multiple transmissions may be multiplexed together, the feedback information transmitted at 440 may include one or multiple codebooks. In other words, feedback for multiple transmissions may be included in one codebook, multiple codebooks, or any combination thereof. That is, the UE 415-a may transmit at least one codebook that indicates the feedback information (e.g., the first feedback information and one or both of the second feedback information and the third feedback information).

In some examples, the feedback information may include feedback responsive to sidelink messages from the UE 415-b (e.g., may include the first feedback information and the second feedback information). In such an example, the UE 415-a may transmit a unicast message to the UE 415-b that includes at least one codebook indicating the feedback information. For example, the unicast message may include a single codebook that indicates the first feedback information and the second feedback information. Alternatively, the unicast message may include a first codebook that indicates the first feedback information and a second codebook that indicates the second feedback information.

In some other examples, the feedback information may include feedback responsive to one or more sidelink messages from the UE 415-b and the UE 415-c. For example, the feedback information may include the first feedback information and one or both of the second feedback information and the third feedback information. In such an example, the UE 415-a may transmit a groupcast message or a broadcast message to the UE 415-b and the UE 415-c that includes at least one codebook indicating the feedback information. For example, the groupcast message or the broadcast message may include a single codebook, a codebook per destination device, or a codebook per sidelink message (e.g., per feedback responsive to a sidelink message).

In some examples, the feedback information transmitted at 440 may include the first feedback information and the third feedback information. In such an example, the UE 415-a may transmit a groupcast message (or a broadcast message) that includes a single codebook that indicates the first feedback information and the third feedback information. Alternatively, the UE 415-a may transmit a groupcast message (or a broadcast message) that includes a first codebook that indicates the first feedback information and a second codebook that indicates the third feedback information.

In some other examples, the feedback information transmitted at 440 may include the first feedback information, the second feedback information, and the third feedback information. In such an example, the UE 415-a may transmit a groupcast message (or a broadcast message) that includes a single codebook that indicates the first feedback information, the second feedback information, and the third feedback information. In some examples, the UE 415-a may transmit a groupcast message (or a broadcast message) that includes a first codebook that indicates the first feedback information, a second codebook that indicates the second feedback information, and third codebook that indicates the third feedback information. In some other examples, the UE 415-a may transmit a groupcast message (or a broadcast message) that includes a first codebook that indicates the first feedback information and the second feedback information (e.g., feedback information for the UE 415-b) and second codebook that indicates the third feedback information (e.g., feedback information for the UE 415-c). In some examples, multiplexing the first feedback information responsive to the first sidelink message with other feedback information responsive to other sidelink messages may reduce latency and increase throughput for sidelink communications between the UEs 415, among other benefits.

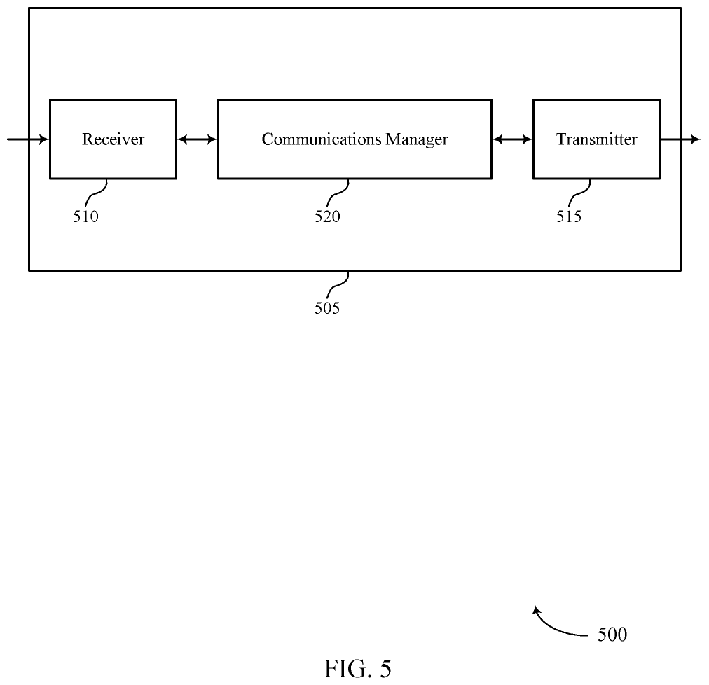

FIG. 5 shows a block diagram 500 of a device 505 that supports asynchronous HARQ feedback for sidelink in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to asynchronous HARQ feedback for sidelink). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to asynchronous HARQ feedback for sidelink). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of asynchronous HARQ feedback for sidelink as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a first UE (e.g., the device 505) in accordance with examples as disclosed herein. For example, the communications manager 520 is capable of, configured to, or operable to support a means for receiving, from a second UE, a sidelink message via one or more sidelink resources (e.g., of a shared RF spectrum band). The communications manager 520 is capable of, configured to, or operable to support a means for selecting a sidelink shared channel resource (e.g., of the shared RF spectrum band) to use for transmission of feedback information associated with the sidelink message, where the selecting is based on one or more conditions and is between at least the sidelink shared channel resource and a sidelink feedback channel resource (e.g., of the shared RF spectrum band). The communications manager 520 is capable of, configured to, or operable to support a means for transmitting, to the second UE, the feedback information via at least the sidelink shared channel resource.

Additionally, or alternatively, the communications manager 520 may support wireless communications at a first UE (e.g., the device 505) in accordance with examples as disclosed herein. For example, the communications manager 520 is capable of, configured to, or operable to support a means for transmitting, to a second UE, a sidelink message via one or more sidelink resources (e.g., of a shared RF spectrum band). The communications manager 520 is capable of, configured to, or operable to support a means for receiving, from the second UE, feedback information associated with the sidelink message, where the feedback information is received via at least a sidelink shared channel resource (e.g., of the shared RF spectrum band) based on a selection of the sidelink shared channel resource from among a set of multiple candidate resources for transmission of the feedback information based on one or more conditions, and where the set of multiple candidate resources includes at least the sidelink shared channel resource and a sidelink feedback channel resource (e.g., of the shared RF spectrum band).

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources.

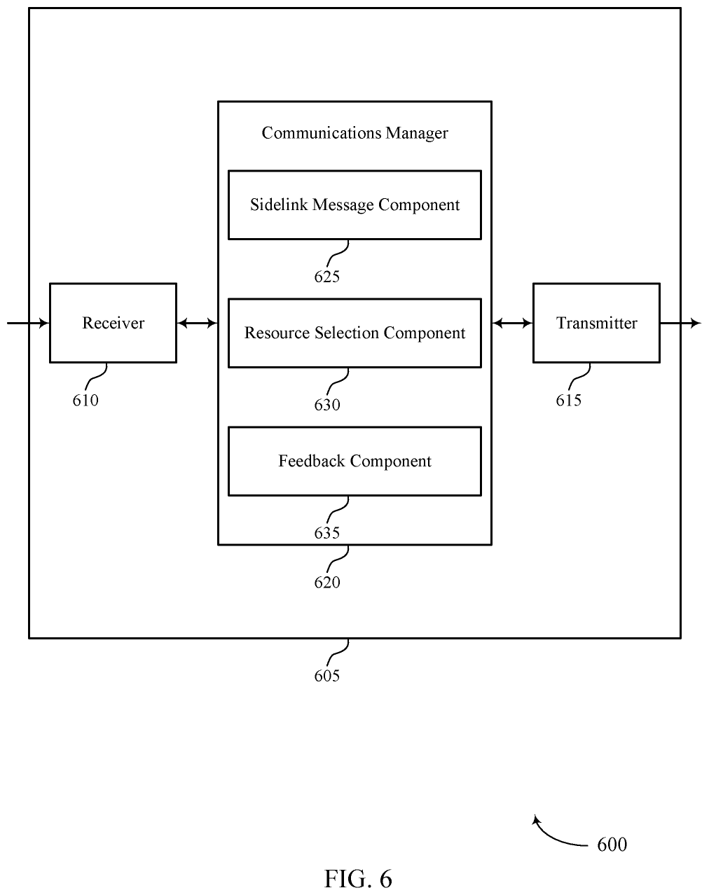

FIG. 6 shows a block diagram 600 of a device 605 that supports asynchronous HARQ feedback for sidelink in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to asynchronous HARQ feedback for sidelink). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to asynchronous HARQ feedback for sidelink). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of asynchronous HARQ feedback for sidelink as described herein. For example, the communications manager 620 may include a sidelink message component 625, a resource selection component 630, a feedback component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first UE (e.g., the device 605) in accordance with examples as disclosed herein. The sidelink message component 625 is capable of, configured to, or operable to support a means for receiving, from a second UE, a sidelink message via one or more sidelink resources (e.g., of a shared RF spectrum band). The resource selection component 630 is capable of, configured to, or operable to support a means for selecting a sidelink shared channel resource (e.g., of the shared RF spectrum band) to use for transmission of feedback information associated with the sidelink message, where the selecting is based on one or more conditions and is between at least the sidelink shared channel resource and a sidelink feedback channel resource (e.g., of the shared RF spectrum band). The feedback component 635 is capable of, configured to, or operable to support a means for transmitting, to the second UE, the feedback information via at least the sidelink shared channel resource.

Additionally, or alternatively, the communications manager 620 may support wireless communications at a first UE (e.g., the device 605) in accordance with examples as disclosed herein. The sidelink message component 625 is capable of, configured to, or operable to support a means for transmitting, to a second UE, a sidelink message via one or more sidelink resources (e.g., of a shared RF spectrum band). The feedback component 635 is capable of, configured to, or operable to support a means for receiving, from the second UE, feedback information associated with the sidelink message, where the feedback information is received via at least a sidelink shared channel resource (e.g., of the shared RF spectrum band) based on a selection of the sidelink shared channel resource from among a set of multiple candidate resources for transmission of the feedback information based on one or more conditions, and where the set of multiple candidate resources includes at least the sidelink shared channel resource and a sidelink feedback channel resource (e.g., of the shared RF spectrum band).

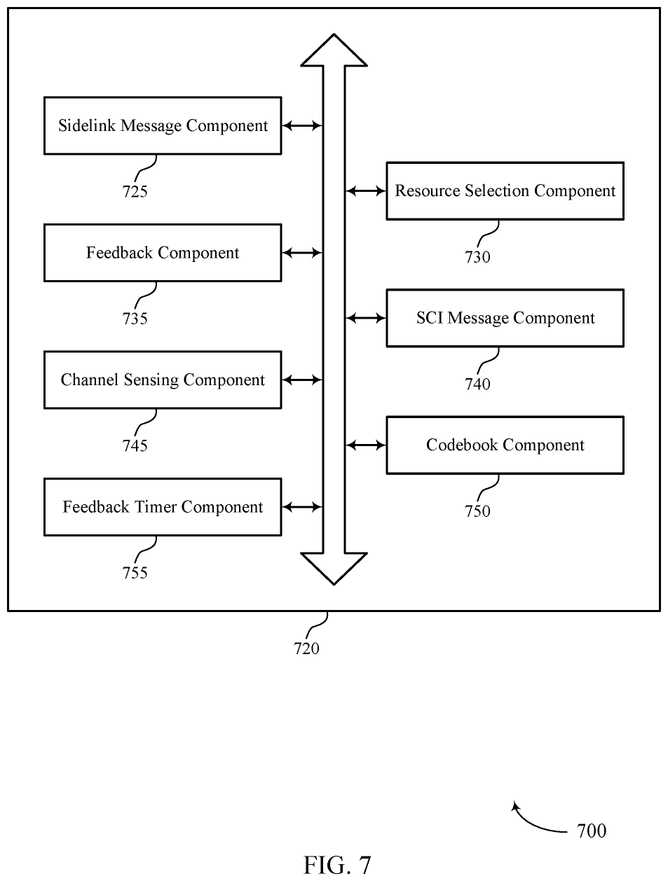

FIG. 7 shows a block diagram 700 of a communications manager 720 that supports asynchronous HARQ feedback for sidelink in accordance with one or more aspects of the present disclosure. The communications manager 720 may be an example of aspects of a communications manager 520, a communications manager 620, or both, as described herein. The communications manager 720, or various components thereof, may be an example of means for performing various aspects of asynchronous HARQ feedback for sidelink as described herein. For example, the communications manager 720 may include a sidelink message component 725, a resource selection component 730, a feedback component 735, an SCI message component 740, a channel sensing component 745, a codebook component 750, a feedback timer component 755, or any combination thereof. Each of these components may communicate, directly or indirectly, with one another (e.g., via one or more buses).

The communications manager 720 may support wireless communications at a first UE in accordance with examples as disclosed herein. The sidelink message component 725 is capable of, configured to, or operable to support a means for receiving, from a second UE, a sidelink message via one or more sidelink resources (e.g., of a shared RF spectrum band). The resource selection component 730 is capable of, configured to, or operable to support a means for selecting a sidelink shared channel resource (e.g., of the shared RF spectrum band) to use for transmission of feedback information associated with the sidelink message, where the selecting is based on one or more conditions and is between at least the sidelink shared channel resource and a sidelink feedback channel resource (e.g., of the shared RF spectrum band). The feedback component 735 is capable of, configured to, or operable to support a means for transmitting, to the second UE, the feedback information via at least the sidelink shared channel resource.

In some examples, to support transmitting the feedback information, the SCI message component 740 is capable of, configured to, or operable to support a means for transmitting an SCI message including the feedback information, where the SCI message includes a MAC-CE or a second-stage SCI message. In some examples, the SCI message component 740 is capable of, configured to, or operable to support a means for transmitting, to the second UE, a first-stage SCI message that indicates that the SCI message includes the feedback information, where the SCI message includes the second-stage SCI message. In some examples, the first-stage SCI message includes a format indicator field associated with the second-stage SCI message, or an indicator bit field, or both, that indicates that the second-stage SCI message includes the feedback information.

In some examples, the SCI message component 740 is capable of, configured to, or operable to support a means for transmitting, to the second UE, a second SCI message including second feedback information that is associated with the feedback information. In some examples, the second SCI message includes the MAC-CE and the SCI message includes the second-stage SCI message.

In some examples, to support transmitting the feedback information, the feedback component 735 is capable of, configured to, or operable to support a means for multiplexing the feedback information with sidelink data on a PSSCH. In some examples, to support transmitting the feedback information, the feedback component 735 is capable of, configured to, or operable to support a means for transmitting the multiplexed feedback information via at least the sidelink shared channel resource on the PSSCH.

In some examples, multiplexing the feedback information with the sidelink data on the PSSCH is based on the feedback information and the sidelink data being associated with a same source identifier or a same destination identifier, the feedback information or the sidelink data satisfying a priority threshold, an availability of the sidelink data, a cast type associated with the sidelink data, or a configuration for multiplexing on the PSSCH, or any combination thereof.

In some examples, to support transmitting the feedback information, the feedback component 735 is capable of, configured to, or operable to support a means for transmitting the feedback information with second feedback information that is associated with a second sidelink message. In some examples, to support transmitting the feedback information with the second feedback information, the codebook component 750 is capable of, configured to, or operable to support a means for transmitting at least one codebook that indicates the feedback information and the second feedback information.

In some examples, to support transmitting the at least one codebook, the codebook component 750 is capable of, configured to, or operable to support a means for transmitting, to the second UE, a unicast message including the at least one codebook. In some examples, to support transmitting the at least one codebook, the codebook component 750 is capable of, configured to, or operable to support a means for transmitting a broadcast message or a groupcast message including the at least one codebook.

In some examples, the at least one codebook includes a codebook that indicates the feedback information and the second feedback information. In some examples, the at least one codebook includes a first codebook that indicates the feedback information and a second codebook that indicates the second feedback information.

In some examples, to support selecting the sidelink shared channel resource, the resource selection component 730 is capable of, configured to, or operable to support a means for selecting the sidelink shared channel resource based on a priority associated with the feedback information.

In some examples, to support selecting the sidelink shared channel resource, the resource selection component 730 is capable of, configured to, or operable to support a means for selecting the sidelink shared channel resource during a resource selection window that is based on a feedback timer. In some examples, a duration of the feedback timer is based on a priority associated with the feedback information, a configured value, a preconfigured value, or a level of congestion associated with sidelink data traffic, or any combination thereof.

In some examples, the sidelink shared channel resource includes a shared RF spectrum band resources and, to support selecting the sidelink shared channel resource, the channel sensing component 745 is capable of, configured to, or operable to support a means for selecting the sidelink shared channel resource based on performing a channel sensing procedure on a set of candidate resources including the sidelink shared channel resource.

In some examples, the channel sensing component 745 is capable of, configured to, or operable to support a means for receiving an indication of a type of channel sensing procedure, where the channel sensing procedure includes the indicated type of channel sensing procedure. In some examples, the sidelink message includes the indication of the type of channel sensing procedure.

In some examples, the one or more conditions include: a cast type associated with the sidelink message, a capability of the second UE, a priority associated with the feedback information, a level of congestion associated with sidelink data traffic, a type of feedback associated with the feedback information, a timing associated with the sidelink shared channel resource, or a timing associated with the sidelink feedback channel resource, a configured value, a preconfigured value, or any combination thereof. In some examples, the feedback information includes HARQ feedback.

Additionally, or alternatively, the communications manager 720 may support wireless communications at a first UE in accordance with examples as disclosed herein. In some examples, the sidelink message component 725 is capable of, configured to, or operable to support a means for transmitting, to a second UE, a sidelink message via one or more sidelink resources (e.g., of a shared RF spectrum band). In some examples, the feedback component 735 is capable of, configured to, or operable to support a means for receiving, from the second UE, feedback information associated with the sidelink message, where the feedback information is received via at least a sidelink shared channel resource (e.g., of the shared RF spectrum band) based on a selection of the sidelink shared channel resource from among a set of multiple candidate resources for transmission of the feedback information based on one or more conditions, and where the set of multiple candidate resources includes at least the sidelink shared channel resource and a sidelink feedback channel resource (e.g., of the shared RF spectrum band).

In some examples, to support receiving the feedback information, the SCI message component 740 is capable of, configured to, or operable to support a means for receiving an SCI message including the feedback information, where the SCI message includes a MAC-CE or a second-stage SCI message. In some examples, the SCI message component 740 is capable of, configured to, or operable to support a means for receiving, from the second UE, a first-stage SCI message that indicates that the SCI message includes the feedback information, where the SCI message includes the second-stage SCI message. In some examples, the first-stage SCI message includes a format indicator field associated with the second-stage SCI message, or an indicator bit field, or both, that indicates that the second-stage SCI message includes the feedback information.

In some examples, the SCI message component 740 is capable of, configured to, or operable to support a means for receiving, from the second UE, a second SCI message including second feedback information that is associated with the feedback information. In some examples, the second SCI message includes the MAC-CE and the SCI message includes the second-stage SCI message.

In some examples, to support receiving the feedback information, the feedback component 735 is capable of, configured to, or operable to support a means for receiving the feedback information via at least the sidelink shared channel resource on a PSSCH, where the feedback information is multiplexed with sidelink data on the PSSCH.

In some examples, to support receiving the feedback information, the feedback component 735 is capable of, configured to, or operable to support a means for receiving the feedback information with second feedback information that is associated with a second sidelink message. In some examples, to support receiving the feedback information with the second feedback information, the codebook component 750 is capable of, configured to, or operable to support a means for receiving at least one codebook that indicates the feedback information and the second feedback information.

In some examples, the at least one codebook includes a codebook that indicates the feedback information and the second feedback information. In some examples, the at least one codebook includes a first codebook that indicates the feedback information and a second codebook that indicates the second feedback information.

In some examples, the selection of the sidelink shared channel resource is based on a priority associated with the feedback information. In some examples, the selection of the sidelink shared channel resource is during a resource selection window that is based on a feedback timer.

In some examples, the sidelink message component 725 is capable of, configured to, or operable to support a means for transmitting, to the second UE, a second sidelink message via a second one or more sidelink resources (e.g., of the shared RF spectrum band). In some examples, the feedback timer component 755 is capable of, configured to, or operable to support a means for identifying an expiration of the feedback timer. In some examples, the feedback component 735 is capable of, configured to, or operable to support a means for transmitting second feedback information associated with the second sidelink message based on the feedback timer being expired, where the second feedback information indicates a negative acknowledgment based on the first UE failing to receive feedback responsive to the second sidelink message during a duration of the feedback timer.

In some examples, a duration of the feedback timer is based on a priority associated with the feedback information, a configured value, a preconfigured value, or a level of congestion associated with sidelink data traffic, or any combination thereof. In some examples, the sidelink shared channel resource includes a shared RF spectrum band resource and the selection of the sidelink shared channel resource is based on a channel sensing procedure performed on a set of candidate resources including the sidelink shared channel resource.

In some examples, the channel sensing component 745 is capable of, configured to, or operable to support a means for transmitting, to the second UE, an indication of a type of channel sensing procedure, where the channel sensing procedure includes the indicated type of channel sensing procedure. In some examples, the sidelink message includes the indication of the type of channel sensing procedure.

In some examples, the one or more conditions include: a cast type associated with the sidelink message, a capability of the second UE, a priority associated with the feedback information, a level of congestion associated with sidelink data traffic, a type of feedback associated with the feedback information, a timing associated with the sidelink shared channel resource, or a timing associated with the sidelink feedback channel resource, a configured value, a preconfigured value, or any combination thereof. In some examples, the feedback information includes HARQ feedback.

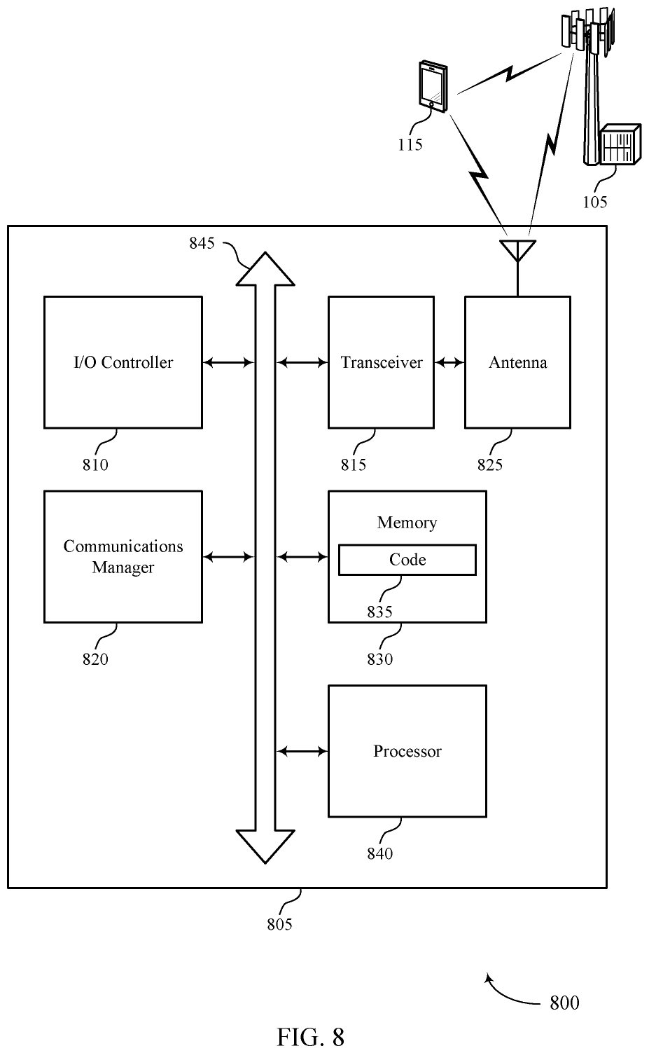

FIG. 8 shows a diagram of a system 800 including a device 805 that supports asynchronous HARQ feedback for sidelink in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting asynchronous HARQ feedback for sidelink). For example, the device 805 or a component of the device 805 may include a processor 840 and memory 830 coupled with or to the processor 840, the processor 840 and memory 830 configured to perform various functions described herein.

The communications manager 820 may support wireless communications at a first UE (e.g., the device 805) in accordance with examples as disclosed herein. For example, the communications manager 820 is capable of, configured to, or operable to support a means for receiving, from a second UE, a sidelink message via one or more sidelink resources (e.g., of a shared RF spectrum band). The communications manager 820 is capable of, configured to, or operable to support a means for selecting a sidelink shared channel resource (e.g., of the shared RF spectrum band) to use for transmission of feedback information associated with the sidelink message, where the selecting is based on one or more conditions and is between at least the sidelink shared channel resource and a sidelink feedback channel resource (e.g., of the shared RF spectrum band). The communications manager 820 is capable of, configured to, or operable to support a means for transmitting, to the second UE, the feedback information via at least the sidelink shared channel resource.

Additionally, or alternatively, the communications manager 820 may support wireless communications at a first UE (e.g., the device 805) in accordance with examples as disclosed herein. For example, the communications manager 820 is capable of, configured to, or operable to support a means for transmitting, to a second UE, a sidelink message via one or more sidelink resources (e.g., of a shared RF spectrum band). The communications manager 820 is capable of, configured to, or operable to support a means for receiving, from the second UE, feedback information associated with the sidelink message, where the feedback information is received via at least a sidelink shared channel resource (e.g., of the shared RF spectrum band) based on a selection of the sidelink shared channel resource from among a set of multiple candidate resources for transmission of the feedback information based on one or more conditions, and where the set of multiple candidate resources includes at least the sidelink shared channel resource and a sidelink feedback channel resource (e.g., of the shared RF spectrum band).

By including or configuring the communications manager 820 in accordance with examples as described herein, the device 805 may support techniques for improved communication reliability, reduced latency, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of asynchronous HARQ feedback for sidelink as described herein, or the processor 840 and the memory 830 may be otherwise configured to perform or support such operations.

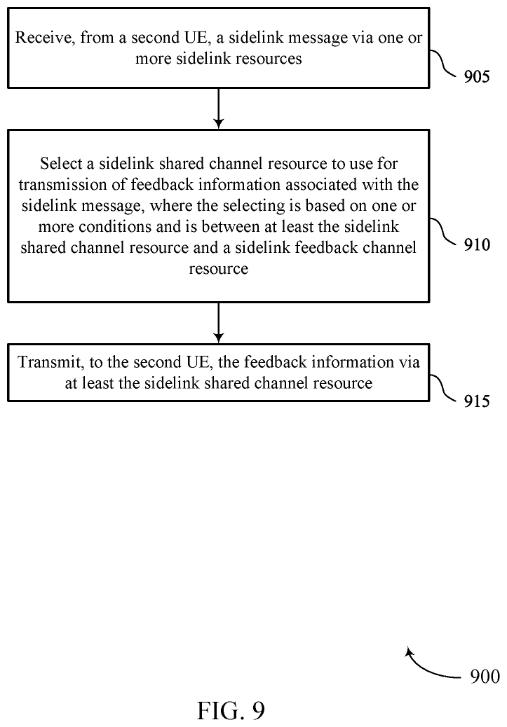

FIG. 9 shows a flowchart illustrating a method 900 that supports asynchronous HARQ feedback for sidelink in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 905, the method may include receiving, from a second UE, a sidelink message via one or more sidelink resources (e.g., of a shared RF spectrum band). The operations of 905 may be performed in accordance with examples as disclosed herein. In some examples, aspects of the operations of 905 may be performed by a sidelink message component 725 as described with reference to FIG. 7.

At 910, the method may include selecting a sidelink shared channel resource (e.g., of the shared RF spectrum band) to use for transmission of feedback information associated with the sidelink message, where the selecting is based on one or more conditions and is between at least the sidelink shared channel resource and a sidelink feedback channel resource (e.g., of the shared RF spectrum band). The operations of 910 may be performed in accordance with examples as disclosed herein. In some examples, aspects of the operations of 910 may be performed by a resource selection component 730 as described with reference to FIG. 7.

At 915, the method may include transmitting, to the second UE, the feedback information via at least the sidelink shared channel resource. The operations of 915 may be performed in accordance with examples as disclosed herein. In some examples, aspects of the operations of 915 may be performed by a feedback component 735 as described with reference to FIG. 7.

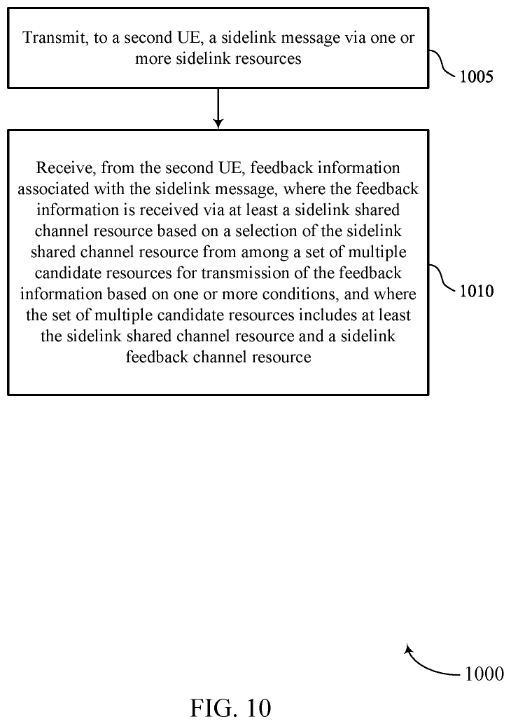

FIG. 10 shows a flowchart illustrating a method 1000 that supports asynchronous HARQ feedback for sidelink in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1005, the method may include transmitting, to a second UE, a sidelink message via one or more sidelink resources (e.g., of a shared RF spectrum band). The operations of 1005 may be performed in accordance with examples as disclosed herein. In some examples, aspects of the operations of 1005 may be performed by a sidelink message component 725 as described with reference to FIG. 7.

At 1010, the method may include receiving, from the second UE, feedback information associated with the sidelink message, where the feedback information is received via at least a sidelink shared channel resource (e.g., of the shared RF spectrum band) based on a selection of the sidelink shared channel resource from among a set of multiple candidate resources for transmission of the feedback information based on one or more conditions, and where the set of multiple candidate resources includes at least the sidelink shared channel resource and a sidelink feedback channel resource (e.g., of the shared RF spectrum band). The operations of 1010 may be performed in accordance with examples as disclosed herein. In some examples, aspects of the operations of 1010 may be performed by a feedback component 735 as described with reference to FIG. 7.

The following provides an overview of aspects of the present disclosure:

Aspect 1: A method for wireless communications at a first UE, comprising: receiving, from a second UE, a sidelink message via one or more sidelink resources; selecting a sidelink shared channel resource to use for transmission of feedback information associated with the sidelink message, wherein the selecting is based at least in part on one or more conditions and is between at least the sidelink shared channel resource and a sidelink feedback channel resource; and transmitting, to the second UE, the feedback information via at least the sidelink shared channel resource.

Aspect 2: The method of aspect 1, wherein transmitting the feedback information comprises: transmitting an SCI message comprising the feedback information, wherein the SCI message comprises a MAC-CE or a second-stage SCI message.

Aspect 3: The method of aspect 2, further comprising: transmitting, to the second UE, a first-stage SCI message that indicates that the SCI message comprises the feedback information, wherein the SCI message comprises the second-stage SCI message.

Aspect 4: The method of aspect 3, wherein the first-stage SCI message comprises a format indicator field associated with the second-stage SCI message, or an indicator bit field, or both, that indicates that the second-stage SCI message comprises the feedback information.

Aspect 5: The method of any of aspects 2 through 4, further comprising: transmitting, to the second UE, a second SCI message comprising second feedback information that is associated with the feedback information.

Aspect 6: The method of aspect 5, wherein the second SCI message comprises the MAC-CE and the SCI message comprises the second-stage SCI message.

Aspect 7: The method of aspect 1, wherein transmitting the feedback information comprises: multiplexing the feedback information with sidelink data on a PSSCH; and transmitting the multiplexed feedback information via at least the sidelink shared channel resource on the PSSCH.

Aspect 8: The method of aspect 7, wherein multiplexing the feedback information with the sidelink data on the PSSCH is based at least in part on the feedback information and the sidelink data being associated with a same source identifier or a same destination identifier, the feedback information or the sidelink data satisfying a priority threshold, an availability of the sidelink data, a cast type associated with the sidelink data, or a configuration for multiplexing on the PSSCH, or any combination thereof.

Aspect 9: The method of aspect 1, wherein transmitting the feedback information comprises: transmitting the feedback information with second feedback information that is associated with a second sidelink message.

Aspect 10: The method of aspect 9, wherein transmitting the feedback information with the second feedback information comprises: transmitting at least one codebook that indicates the feedback information and the second feedback information.

Aspect 11: The method of aspect 10, wherein the second sidelink message is received from the second UE, and wherein transmitting the at least one codebook comprises: transmitting, to the second UE, a unicast message comprising the at least one codebook.

Aspect 12: The method of aspect 10, wherein the second sidelink message is received from a third UE that is different from the second UE, and wherein transmitting the at least one codebook comprises: transmitting a broadcast message or a groupcast message comprising the at least one codebook.

Aspect 13: The method of any of aspects 10 through 12, wherein the at least one codebook comprises a codebook that indicates the feedback information and the second feedback information, or the at least one codebook comprises a first codebook that indicates the feedback information and a second codebook that indicates the second feedback information.

Aspect 14: The method of any of aspects 1 through 13, wherein selecting the sidelink shared channel resource comprises: selecting the sidelink shared channel resource based at least in part on a priority associated with the feedback information.

Aspect 15: The method of any of aspects 1 through 14, wherein selecting the sidelink shared channel resource comprises: selecting the sidelink shared channel resource during a resource selection window that is based at least in part on a feedback timer.

Aspect 16: The method of aspect 15, wherein a duration of the feedback timer is based at least in part on a priority associated with the feedback information, a configured value, a preconfigured value, or a level of congestion associated with sidelink data traffic, or any combination thereof.

Aspect 17: The method of any of aspects 1 through 16, wherein the sidelink shared channel resource comprises a shared RF spectrum band resource, and wherein selecting the sidelink shared channel resource comprises: selecting the sidelink shared channel resource based at least in part on performing a channel sensing procedure on a set of candidate resources including the sidelink shared channel resource.

Aspect 18: The method of aspect 17, further comprising: receiving an indication of a type of channel sensing procedure, wherein the channel sensing procedure comprises the indicated type of channel sensing procedure.

Aspect 19: The method of aspect 18, wherein the sidelink message comprises the indication of the type of channel sensing procedure.

Aspect 20: The method of any of aspects 1 through 19, wherein the one or more conditions comprise a cast type associated with the sidelink message, a capability of the second UE, a priority associated with the feedback information, a level of congestion associated with sidelink data traffic, a type of feedback associated with the feedback information, a timing associated with the sidelink shared channel resource, or a timing associated with the sidelink feedback channel resource, a configured value, a preconfigured value, or any combination thereof.

Aspect 21: The method of any of aspects 1 through 20, wherein the feedback information comprises HARQ feedback.

Aspect 22: A method for wireless communications at a first UE, comprising: transmitting, to a second UE, a sidelink message via one or more sidelink resources; and receiving, from the second UE, feedback information associated with the sidelink message, wherein the feedback information is received via at least a sidelink shared channel resource based at least in part on a selection of the sidelink shared channel resource from among a plurality of candidate resources for transmission of the feedback information based at least in part on one or more conditions, and wherein the plurality of candidate resources comprises at least the sidelink shared channel resource and a sidelink feedback channel resource.

Aspect 23: The method of aspect 22, wherein receiving the feedback information comprises: receiving an SCI message comprising the feedback information, wherein the SCI message comprises a MAC-CE or a second-stage SCI message.

Aspect 24: The method of aspect 23, further comprising: receiving, from the second UE, a first-stage SCI message that indicates that the SCI message comprises the feedback information, wherein the SCI message comprises a second-stage SCI message.

Aspect 25: The method of aspect 24, wherein the first-stage SCI message comprises a format indicator field associated with the second-stage SCI message, or an indicator bit field, or both, that indicates that the second-stage SCI message comprises the feedback information.

Aspect 26: The method of any of aspects 23 through 25, further comprising: receiving, from the second UE, a second SCI message comprising second feedback information that is associated with the feedback information.

Aspect 27: The method of aspect 26, wherein the second SCI message comprises a MAC-CE and the SCI message comprises a second-stage SCI message.

Aspect 28: The method of aspect 22, wherein receiving the feedback information comprises: receiving the feedback information via at least the sidelink shared channel resource on a PSSCH, wherein the feedback information is multiplexed with sidelink data on the PSSCH.

Aspect 29: The method of aspect 22, wherein receiving the feedback information comprises: receiving the feedback information with second feedback information that is associated with a second sidelink message.

Aspect 30: The method of aspect 29, wherein receiving the feedback information with the second feedback information comprises: receiving at least one codebook that indicates the feedback information and the second feedback information.

Aspect 31: The method of aspect 30, wherein the at least one codebook comprises a codebook that indicates the feedback information and the second feedback information, or the at least one codebook comprises a first codebook that indicates the feedback information and a second codebook that indicates the second feedback information.

Aspect 32: The method of any of aspects 22 through 31, wherein the selection of the sidelink shared channel resource is based at least in part on a priority associated with the feedback information.

Aspect 33: The method of any of aspects 22 through 32, wherein the selection of the sidelink shared channel resource is during a resource selection window that is based at least in part on a feedback timer.

Aspect 34: The method of aspect 33, further comprising: transmitting, to the second UE, a second sidelink message via a second one or more sidelink resources; identifying an expiration of the feedback timer; and transmitting second feedback information associated with the second sidelink message based at least in part on the feedback timer being expired, wherein the second feedback information indicates a negative acknowledgment based at least in part on the first UE failing to receive feedback responsive to the second sidelink message during a duration of the feedback timer.

Aspect 35: The method of any of aspects 33 through 34, wherein a duration of the feedback timer is based at least in part on a priority associated with the feedback information, a configured value, a preconfigured value, or a level of congestion associated with sidelink data traffic, or any combination thereof.

Aspect 36: The method of any of aspects 22 through 35, wherein the selection of the sidelink shared channel resource is based at least in part on a channel sensing procedure performed on a set of candidate resources including the sidelink shared channel resource.

Aspect 37: The method of aspect 36, further comprising: transmitting, to the second UE, an indication of a type of channel sensing procedure, wherein the channel sensing procedure comprises the indicated type of channel sensing procedure.

Aspect 38: The method of aspect 37, wherein the sidelink message comprises the indication of the type of channel sensing procedure.

Aspect 39: The method of any of aspects 22 through 38, wherein the one or more conditions comprise a cast type associated with the sidelink message, a capability of the second UE, a priority associated with the feedback information, a level of congestion associated with sidelink data traffic, a type of feedback associated with the feedback information, a timing associated with the sidelink shared channel resource, or a timing associated with the sidelink feedback channel resource, or any combination thereof.

Aspect 40: The method of any of aspects 22 through 39, wherein the feedback information comprises HARQ feedback.

Aspect 41: An apparatus for wireless communications at a first UE, comprising at least one processor; at least one memory coupled with the at least one processor; and instructions stored in the at least one memory and executable by the at least one processor to cause the apparatus to perform a method of any of aspects 1 through 21.

Aspect 42: An apparatus for wireless communications at a first UE, comprising at least one means for performing a method of any of aspects 1 through 21.

Aspect 43: A non-transitory computer-readable medium storing code for wireless communications at a first UE, the code comprising instructions executable by a processor to perform a method of any of aspects 1 through 21.

Aspect 44: An apparatus for wireless communications at a first UE, comprising at least one processor; at least one memory coupled with the at least one processor; and instructions stored in the at least one memory and executable by the at least one processor to cause the apparatus to perform a method of any of aspects 22 through 40.

Aspect 45: An apparatus for wireless communications at a first UE, comprising at least one means for performing a method of any of aspects 22 through 40.

Aspect 46: A non-transitory computer-readable medium storing code for wireless communications at a first UE, the code comprising instructions executable by a processor to perform a method of any of aspects 22 through 40.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
at least one processor; and
at least one memory coupled with the at least one processor, the at least one memory storing instructions executable by the at least one processor to cause the apparatus to:
receive, from a second UE, a sidelink message via one or more sidelink resources;
select a sidelink shared channel resource to use for transmission of feedback information associated with the sidelink message, wherein the selecting is based at least in part on one or more conditions and is between at least the sidelink shared channel resource and a sidelink feedback channel resource; and
transmit, to the second UE, the feedback information via at least the sidelink shared channel resource.

2. The apparatus of claim 1, wherein, to transmit the feedback information, the instructions are executable by the at least one processor to cause the apparatus to:
transmit a sidelink control information message comprising the feedback information, wherein the sidelink control information message comprises a medium access control control element or a second-stage sidelink control information message.

3. The apparatus of claim 2, wherein the instructions are further executable by the at least one processor to cause the apparatus to:
transmit, to the second UE, a first-stage sidelink control information message that indicates that the sidelink control information message comprises the feedback information, wherein the sidelink control information message comprises the second-stage sidelink control information message.

4. The apparatus of claim 3, wherein the first-stage sidelink control information message comprises a format indicator field associated with the second-stage sidelink control information message, or an indicator bit field, or both, that indicates that the second-stage sidelink control information message comprises the feedback information.

5. The apparatus of claim 2, wherein the instructions are further executable by the at least one processor to cause the apparatus to:
transmit, to the second UE, a second sidelink control information message comprising second feedback information that is associated with the feedback information.

6. The apparatus of claim 5, wherein the second sidelink control information message comprises the medium access control control element and the sidelink control information message comprises the second-stage sidelink control information message.

7. The apparatus of claim 1, wherein, to transmit the feedback information, the instructions are executable by the at least one processor to cause the apparatus to:
multiplex the feedback information with sidelink data on a physical sidelink shared channel; and
transmit the multiplexed feedback information via at least the sidelink shared channel resource on the physical sidelink shared channel.

8. The apparatus of claim 7, wherein the instructions are executable by the at least one processor to cause the apparatus to multiplex the feedback information with the sidelink data on the physical sidelink shared channel based at least in part on the feedback information and the sidelink data being associated with a same source identifier or a same destination identifier, the feedback information or the sidelink data satisfying a priority threshold, an availability of the sidelink data, a cast type associated with the sidelink data, or a configuration for multiplexing on the physical sidelink shared channel, or any combination thereof.

9. The apparatus of claim 1, wherein, to transmit the feedback information, the instructions are executable by the at least one processor to cause the apparatus to:
transmit the feedback information with second feedback information that is associated with a second sidelink message.

10. The apparatus of claim 9, wherein, to transmit the feedback information with the second feedback information, the instructions are executable by the at least one processor to cause the apparatus to:
transmit at least one codebook that indicates the feedback information and the second feedback information.

11. The apparatus of claim 10, wherein, to transmit the at least one codebook, the instructions are executable by the at least one processor to cause the apparatus to:
transmit, to the second UE, a unicast message comprising the at least one codebook.

12. The apparatus of claim 10, wherein, to transmit the at least one codebook, the instructions are executable by the at least one processor to cause the apparatus to:
transmit a broadcast message or a groupcast message comprising the at least one codebook.

13. The apparatus of claim 10, wherein:
the at least one codebook comprises a codebook that indicates the feedback information and the second feedback information, or
the at least one codebook comprises a first codebook that indicates the feedback information and a second codebook that indicates the second feedback information.

14. The apparatus of claim 1, wherein, to select the sidelink shared channel resource, the instructions are executable by the at least one processor to cause the apparatus to:
select the sidelink shared channel resource based at least in part on a priority associated with the feedback information.

15. The apparatus of claim 1, wherein, to select the sidelink shared channel resource, the instructions are executable by the at least one processor to cause the apparatus to:
select the sidelink shared channel resource during a resource selection window that is based at least in part on a feedback timer.

16. The apparatus of claim 15, wherein a duration of the feedback timer is based at least in part on a priority associated with the feedback information, a configured value, a preconfigured value, or a level of congestion associated with sidelink data traffic, or any combination thereof.

17. The apparatus of claim 1, wherein the sidelink shared channel resource comprises a shared radio frequency spectrum band resource, and wherein, to select the sidelink shared channel resource, the instructions are executable by the at least one processor to cause the apparatus to:
select the sidelink shared channel resource based at least in part on performing a channel sensing procedure on a set of candidate resources including the sidelink shared channel resource.

18. The apparatus of claim 17, wherein the instructions are further executable by the at least one processor to cause the apparatus to:
receive an indication of a type of channel sensing procedure, wherein the channel sensing procedure comprises the indicated type of channel sensing procedure.

19. The apparatus of claim 18, wherein the sidelink message comprises the indication of the type of channel sensing procedure.

20. The apparatus of claim 1, wherein the one or more conditions comprise a cast type associated with the sidelink message, a capability of the second UE, a priority associated with the feedback information, a level of congestion associated with sidelink data traffic, a type of feedback associated with the feedback information, a timing associated with the sidelink shared channel resource, or a timing associated with the sidelink feedback channel resource, a configured value, a preconfigured value, or any combination thereof.

21. The apparatus of claim 1, wherein the feedback information comprises hybrid automatic repeat request feedback.

22. An apparatus for wireless communications at a first user equipment (UE), comprising:
at least one processor; and
at least one memory coupled with the at least one processor, the at least one memory storing instructions executable by the at least one processor to cause the apparatus to:
transmit, to a second UE, a sidelink message via one or more sidelink resources; and
receive, from the second UE, feedback information associated with the sidelink message, wherein the feedback information is received via at least a sidelink shared channel resource based at least in part on a selection of the sidelink shared channel resource from among a plurality of candidate resources for transmission of the feedback information based at least in part on one or more conditions, and wherein the plurality of candidate resources comprises at least the sidelink shared channel resource and a sidelink feedback channel resource.

23. The apparatus of claim 22, wherein, to receive the feedback information, the instructions are executable by the at least one processor to cause the apparatus to:
receive a sidelink control information message comprising the feedback information, wherein the sidelink control information message comprises a medium access control control element or a second-stage sidelink control information message.

24. The apparatus of claim 22, wherein, to receive the feedback information, the instructions are executable by the at least one processor to cause the apparatus to:
receive the feedback information via at least the sidelink shared channel resource on a physical sidelink shared channel, wherein the feedback information is multiplexed with sidelink data on the physical sidelink shared channel.

25. The apparatus of claim 22, wherein, to receive the feedback information, the instructions are executable by the at least one processor to cause the apparatus to:
receive the feedback information with second feedback information that is associated with a second sidelink message.

26. The apparatus of claim 22, wherein the instructions are executable by the at least one processor to cause the apparatus to select the sidelink shared channel resource during a resource selection window that is based at least in part on a feedback timer.

27. The apparatus of claim 26, wherein the instructions are further executable by the at least one processor to cause the apparatus to:
transmit, to the second UE, a second sidelink message via a second one or more sidelink resources;
identify an expiration of the feedback timer; and
transmit second feedback information associated with the second sidelink message based at least in part on the feedback timer being expired, wherein the second feedback information indicates a negative acknowledgment based at least in part on the first UE failing to receive feedback responsive to the second sidelink message during a duration of the feedback timer.

28. The apparatus of claim 26, wherein a duration of the feedback timer is based at least in part on a priority associated with the feedback information, a configured value, a preconfigured value, or a level of congestion associated with sidelink data traffic, or any combination thereof.

29. A method for wireless communications at a first user equipment (UE), comprising:
receiving, from a second UE, a sidelink message via one or more sidelink resources;
selecting a sidelink shared channel resource of to use for transmission of feedback information associated with the sidelink message, wherein the selecting is based at least in part on one or more conditions and is between at least the sidelink shared channel resource and a sidelink feedback channel resource; and
transmitting, to the second UE, the feedback information via at least the sidelink shared channel resource.

30. A method for wireless communications at a first user equipment (UE), comprising:
transmitting, to a second UE, a sidelink message via one or more sidelink resources; and
receiving, from the second UE, feedback information associated with the sidelink message, wherein the feedback information is received via at least a sidelink shared channel resource based at least in part on a selection of the sidelink shared channel resource from among a plurality of candidate resources for transmission of the feedback information based at least in part on one or more conditions, and wherein the plurality of candidate resources comprises at least the sidelink shared channel resource and a sidelink feedback channel resource.
